(19) United States
(12) Patent Application Publication
(10) Pub. No.: US 2026/0045543 A1
(43) Pub. Date: Feb. 12, 2026

(54) DELOCALIZED LITHIUM ION FLUX BY SOLID-STATE ELECTROLYTE COMPOSITES COUPLED WITH 3D POROUS NANOSTRUCTURES FOR HIGHLY STABLE LITHIUM METAL BATTERIES

(71) Applicant: The Texas A&M University System, College Station, TX (US)

(72) Inventors: Choongho Yu, College Station, TX (US); Jooyoung Lee, College Station, TX (US)

(73) Assignee: The Texas A&M University System, College Station, TX (US)

(21) Appl. No.: 19/100,573

(22) PCT Filed: Aug. 1, 2023
(86) PCT No.: PCT/US2023/029240

§ 371 Date: Feb. 2, 2025

Related U.S. Application Data
(60) Provisional application No. 63/394,334, filed on Aug. 2, 2022.

(51) Int. Cl. H01M 10/0562; H01M 4/587

(52) U.S. Cl. CPC H01M 10/0562; H01M 4/587; H01M 2300/0071; H01M 2300/0091

(57) ABSTRACT

A lithium metal anode that reduces formation of lithium dendrites includes a porous carbon nanotube (CNT) electrode, a solid-state electrolyte (SE) composite layer disposed on the porous CNT electrode, and a polypropylene (PP) separator layer disposed on the SE composite layer. The SE composite layer induces uniform lithium growth, suppressing dendrite growth. The suppression of dendrite growth improves performance lithium-based designs and enables improved capacity retention.

### TECHNICAL FIELD

The present disclosure relates to lithium-ion batteries and more particularly, but not by way of limitation, to synergistic effects of delocalized lithium-ion flux by sold-state electrolyte composites coupled with 3D porous framework for highly stable lithium metal batteries.

### BACKGROUND

This section provides background information to facilitate a better understanding of the various aspects of the disclosure. It should be understood that the statements in this section of this document are to be read in this light, and not as admissions of prior art.

The prosperity of electric vehicles demands high energy density batteries, which has substantially improved the cathodes of rechargeable lithium-based batteries over the past decades. Further increase of the energy density necessitates significant advance in their anodes. Lithium (Li) metal is the front runner because of its high specific capacity (3,860 mAh g⁻¹) compared to graphite (350 mAh g⁻¹), the lowest electrode potential (−3.04 V vs. SHE) over all possible alternatives, and a low gravimetric density (0.534 g cm⁻³). However. Li metal anodes have yet to be adopted in the industry due to safety issues and rapid capacity fading. These detrimental side effects were caused primarily by Li dendrite growth as a result of non-uniform Li plating and stripping and large volume changes. The Li dendrite growth is considerably furthered when lithium-ion (Li⁺) flux is non-uniformly distributed over limited anode surfaces such as foil-like two-dimensional (2D) Li metal. The relatively large pore size and low porosity of conventional separators in typical liquid electrolyte-based batteries make Li⁺ flux concentrated on the anode. The limited surface areas of the 2D Li metal anode accompany large volume changes which cause frequent disruption of solid-electrolyte interphase (SEI) layers, resulting in Li consumption and dendrite growth. To overcome these problems, separator-free all-solid-state batteries have been rigorously studied, but low ionic conductivity, narrow voltage windows, and unstable interfacial contacts are still challenging despite recent massive investments.

### BRIEF DESCRIPTION OF THE DRAWINGS

A more complete understanding of the subject matter of the present disclosure may be obtained by reference to the following Detailed Description when taken in conjunction with the accompanying Drawings wherein:

FIG. 1(a) illustrates a solid-state electrolyte (SE) composite separator paired with a 3D CNT anode, according to aspects of the disclosure. The inset is a close-up showing that the SE composite separator and 3D CNT framework are firmly attached by the large contact surfaces between the entangled CNT and polymer. FIG. 1(b) illustrates a cross-section displaying concentrated Li+ flux (illustrated as small dots) in a PP separator being delocalized in a composite containing SE particles (illustrated as dots in the middle layer), and then inserted into the pores of a CNT framework (lines in the bottom layer) and plated on the CNT surface. The pores in the framework are filled with Li metal. FIG. 1(c) illustrates a conventional PP separator and 2D Li metal anode pair, Li dendrites readily sprout from the Li metal anode towards the gap in between. The inset is a close-up of the dendrite formation. FIG. 1(d) illustrates non-uniformly distributed Li+ flux through the PP separator generates dendrites due to localized Li plating on the limited surface areas of 2D Li metal.

FIG. 2: (a) FEA simulation geometry for SE|CNT pair. Li⁺ concentration distribution through (b) Normalized Li⁺ concentration for PP|CNT and SE|CNT. Results of additional cases are represented in the inset of FIG. 2(b). Li⁺ concentration calculation line at a distance of 1 μm beneath the separator for each pair was selected to normalize Li⁺ concentration.

FIG. 3: FEA simulation geometries for (a) PP|Li pair, (b) SE|Li pair, (c) PP|CNT pair, and (d) SE|CNT pair. Length unit for each figure is μm.

FIG. 4 is an illustration of a battery configuration with a composite separator and elastic porous layer.

### DETAILED DESCRIPTION

It is to be understood that the following disclosure provides many different embodiments, or examples, for implementing different features of various embodiments. Specific examples of components and arrangements are described below to simplify the disclosure. These are, of course, merely examples and are not intended to be limiting. The section headings used herein are for organizational purposes and are not to be construed as limiting the subject matter described.

The anodes of the instant disclosure address the root cause of failure of Li anodes when employing conventional/composite separators and/or porous anodes. In particular, the anodes of the instant disclosure address the non-uniform Li⁺ flux, which results in preferential Li plating/stripping. Porous anodes alone are subject to clogging with moderate/high loading cathodes. Here we discovered it is necessary to seek synergy from our separator and anode pair for delivering delocalized Li⁺ to the anode and then uniformly plate Li metal over the large surface areas of the porous anode. Using a polymer composite separator containing solid-state electrolyte (SE) can provide numerous Li⁺ passages through the percolated SE and pore networks, allowing for more uniform Li plating. Finite element analysis and comparative tests demonstrate the synergy between the homogeneous Li⁺ flux and current density reduction on the anode. The composite separators discussed herein induce compact and uniform Li plating with robust inorganic-rich solid electrolyte interphase layers. The porous anode lowered the nucleation overpotential and interfacial contact impedance during Li plating. Full cell tests with LiFePO₄ and Li [Ni_{0.8}Mn_{0.1}Co_{0.1}]O₂(NMC811) exhibited remarkable cycling behaviors, ˜80% capacity retention at the 750^{th} and 235^{th} cycle, respectively. A high-loading NMC811 (4 mAh cm⁻²) full cell has displayed maximum cell-level energy densities of 334 Wh kg⁻¹ and 783 Wh L⁻¹. This work proposes a solution for raising energy density by adopting Li metal, which could be a viable option considering only incremental advancement in the conventional cathodes lately.

Here the root cause of failure has been identified particularly when a pair of the conventional separator and Li metal foil, recently emerged composite separators, or porous anodes were used. Then an immediately deployable solution has been suggested by exploiting the advantages of liquid and solid-state electrolytes, which do not require modifications in the cathode and operating conditions of conventional Li-ion batteries. More specifically, our study has sought synergistic effects by pairing composite separators containing a solid-state electrolyte (SE) and a 3D porous scaffold anode made of carbon nanotube (CNT) to mitigate the aforementioned problems. Recently, composite membranes have been examined as alternatives for conventional separators, mainly targeting the extended lifetime of Li metal-based batteries. Nonetheless, the composites have shown limitations such as complicated manufacturing processes, undesirably thick composite layers, and poor capacity retention compared to typical polymer separators in conventional cells. In advanced Li-ion batteries coupling 2D Li metal anodes and high-capacity cathodes, Li dendrites were inevitably generated regardless of the distribution of Li⁺ flux near the separator due to the repetitive destruction and creation of SEI during cycling, suggesting the importance of alleviating the local current density near the anode surface.

An effective approach for mitigating the limited surface of flat Li metal is to employ a 3D host framework as an anode. Porous frameworks are often made of electronically-conducting materials including porous copper, CNT, and graphene. The large surface areas of the frameworks can reduce the local current density and mitigate repeated breakage of the SEI layer by shrinking the volume change of Li metal during stripping and plating. Unlike conventional graphite-based anodes, these cells are to be continuously charged beyond lithiation until the pores are filled with Li metal. However, the electric field near the inlet of the pores (i.e., separator side) of the electrode is stronger than the inner part, accelerating the preferential deposition of Li metal and eventually clogging the pore at the inlet (i.e., impairing the inner pores). To circumvent the clogging problem, the electric field at the pore inlet needs to be attenuated. Recent studies have shown thin electronically-insulating coating layers such as metal-organic framework and alumina layer are effective, but they require significant efforts to keep the layer thin enough to pass Li⁺ without considerably introducing unwanted impedance. Still, when Li⁺ flux is localized on this type of porous framework, Li dendrites tend to sprout from the surface of the porous anodes.

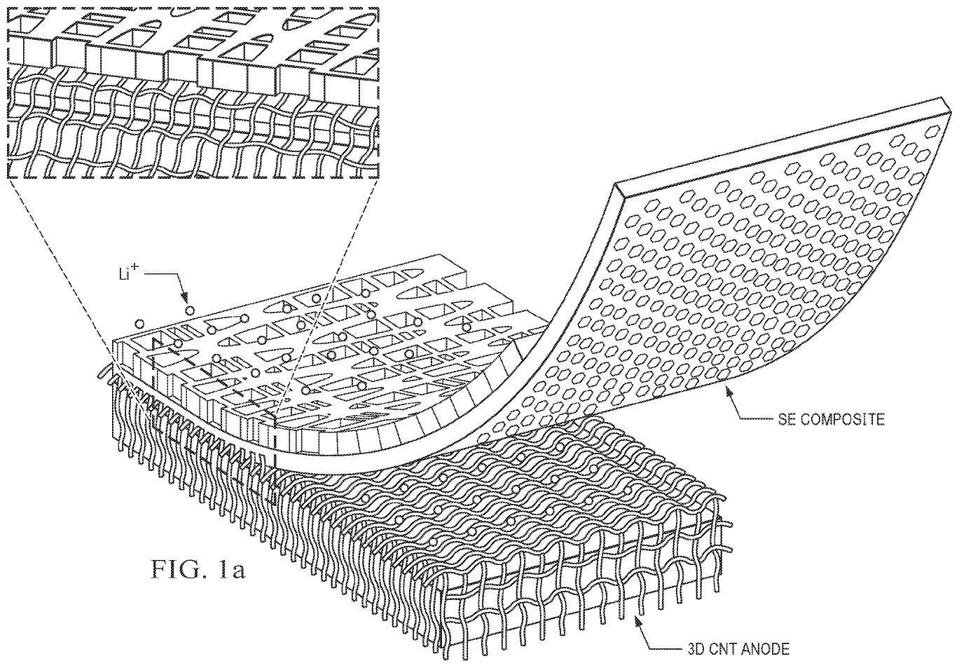

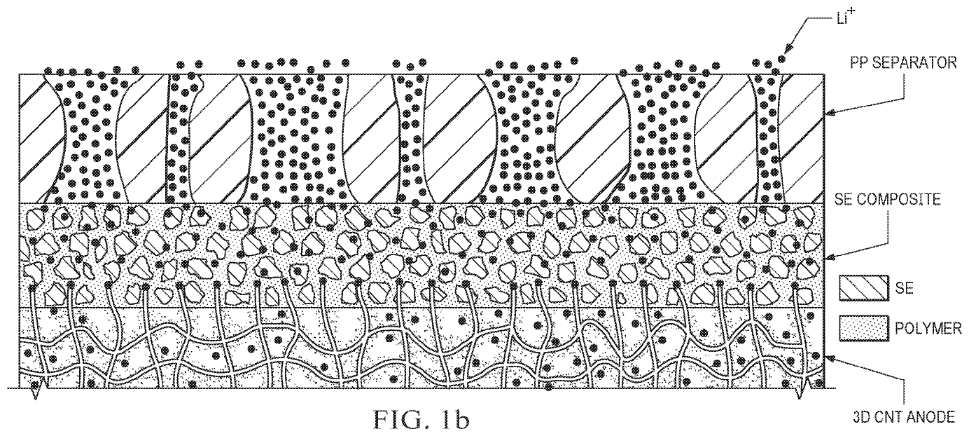

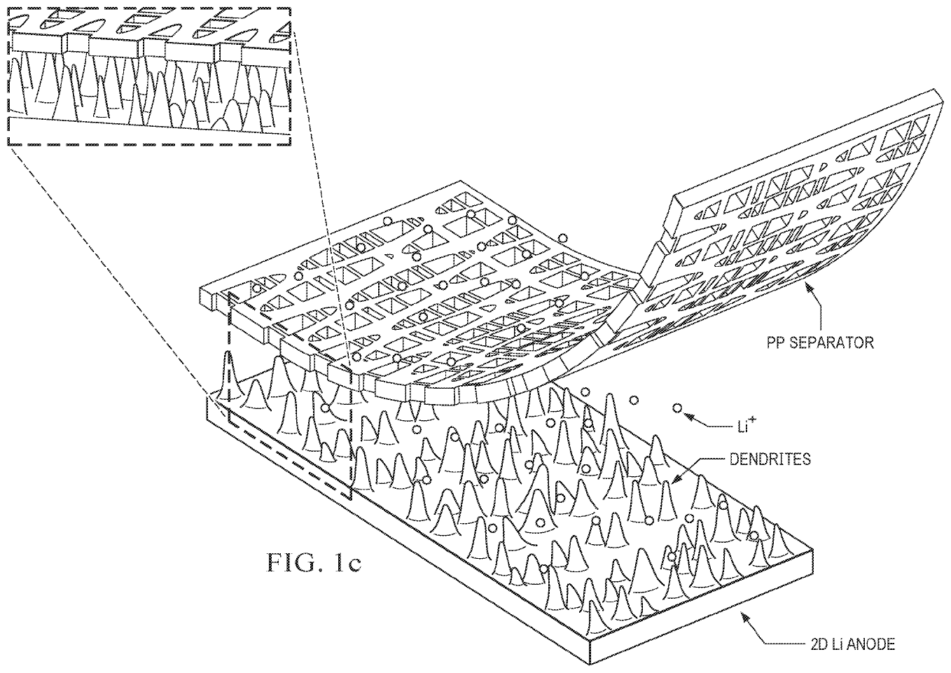

This work has demonstrated our synergistic approach coupling a composite separator and a porous 3D CNT electrode could resolve the problems with the Li metal anode, as illustrated in FIGS. 1(a) and 1(b), in contrast to conventional cells utilizing commercial polypropylene (PP) separators (FIGS. 1(c) and 1(d)). In the past, most efforts have been devoted to the development of Li metal anodes with porous frameworks or novel separators. However, our series of simulations and experimental results have unveiled that such individual components are unlikely to address the detrimental problems so it is necessary to introduce effects beyond what individual separators and anodes can offer. Our electronically insulating composite layer can delocalize Li⁺ flux passing through the PP separator. Our CNT was self-entangled during the synthesis process and formed into 3D porous structures having superb mechanical resiliency without any binders. The large contact area between the polymer layer and CNT prevents delamination, which is crucial in eliminating the voids between the separator and anode. Conversely, conventional PP separators and anodes cannot preclude the formation of the voids in between, accelerating Li dendrite growth along with the localized Li⁺ transport through the PP separators (FIG. 1(d)). The delocalized Li⁺ through our composite separator is readily inserted into the pores and then plated over the entire CNT surfaces, effectively inhibiting the clogging issue of the 3D host framework (FIG. 1(b)). Through finite element analysis (FEA) numerical simulations, we theoretically predicted the different trends of Li⁺ concentration distribution across the separator in each case; from the commercial PP separator and 2D Li metal anode to the proposed SE composite separator and 3D CNT anode. Next, we thoroughly characterized each component, showing a high Li⁺ transference number of our composite separator and low Li nucleation potential of our 3D CNT anode as well as the roles of each component in the cell, unveiling that desirable outcomes can be obtained only when both the composite separator and CNT anode were paired. Furthermore, full-cell tests with low and high voltage cathodes have demonstrated the practicality of our approach in boosting energy densities and cycling performances.

### RESULT AND DISCUSSION

Our composite separator and CNT anode were fabricated by coating the composite containing Li_{6.4}La₃Zr_{1.4}Ta_{0.6}O₁₂ (LLZTO) and poly(vinylidene fluoride-co-hexafluoropropylene (PVDF-HFP) on a commercial polypropylene (PP) separator, and then firmly attached to the CNT electrode. We employed the PVDF-HFP polymer to bind LLZTO SE particles because the pores of PVDF-HFP are copious and small enough to distribute Li⁺. The intrinsically low crystalline structure and strong electron-withdrawing functional group (—C—F) of PVDF-HFP lead to a high dielectric constant and a decent ionic conductivity at room temperature compared to the other polymers including poly(ethylene oxide), polyacrylonitrile, poly(methyl methacrylate), and polyimide. However, PVDF-HFP is unstable under a typical cycling voltage (>4 V) of Li-ion batteries. This shortcoming could be alleviated by blending ceramic fillers such as TiO₂, SiO₂, Al₂O₃, BaTiO₃, and solid-state electrolyte particles including Li_{1.5}Al_{0.5}Ge_{1.5}(PO₄)₃ (LAGP) and Li₇La₃Zr₂O₁₂ (LLZO) with PVDF-HFP. Here we have selected LLZTO to fabricate our flexible SE composites due to its high mechanical rigidity and Li⁺ attracting characteristic.

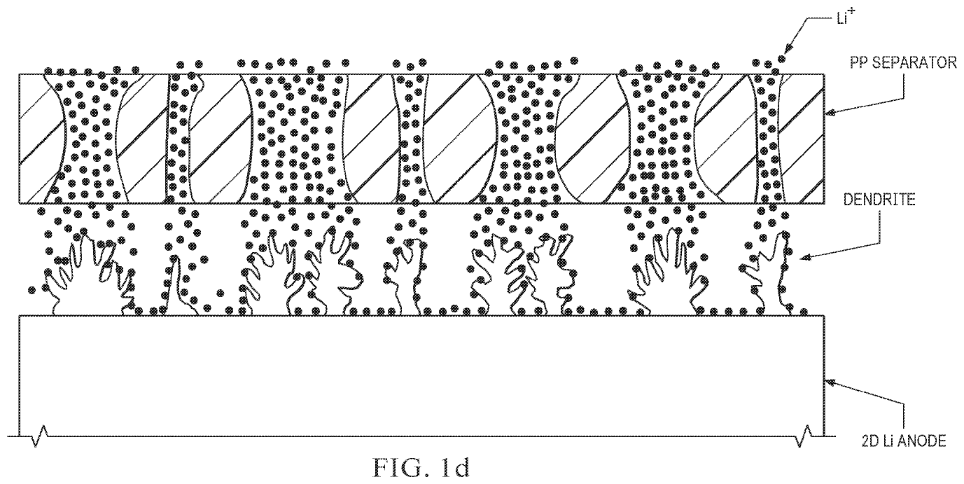

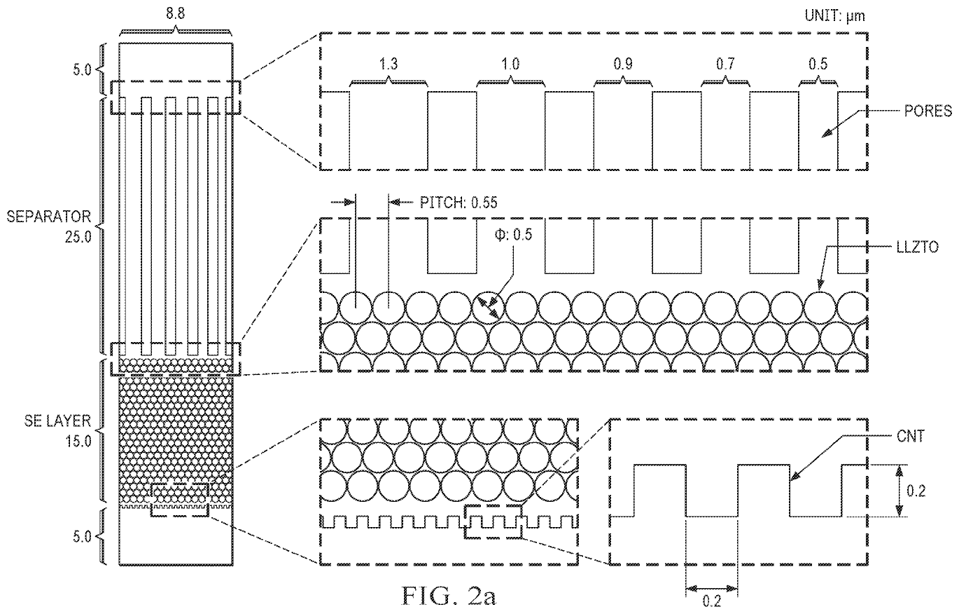

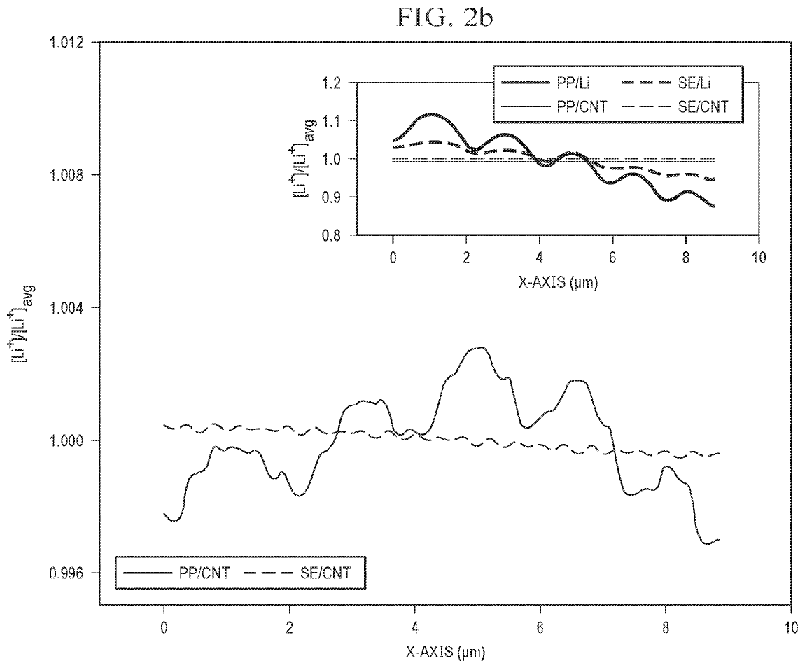

FEA numerical simulations (COMSOL Multiphysics 6.0) were conducted to analyze the difference in Li⁺ migration trend and concentration distribution for the case where the SE separator and CNT anode framework were applied compared to the case where the commercial PP separator and 2D Li metal anode were used. Detailed 2-dimensional geometry domain information for each separator|anode pair is summarized in FIGS. 2(a)-2(b). The non-uniformly distributed vertical pores of PP separator, spherical LLZTO particle arrays of the SE layer, and the large corrugated surface area of CNT were applied to each simulation geometry domain, and the representative domain (SE|CNT) which exhibits all these characteristics is represented in FIG. 2(a). For the PP|Li separator-anode pair case, Li⁺ migrates from the cathode to the anode (vertically) through the liquid electrolyte filled in the non-uniform pores inside the PP separator. Due to the non-even pores and spacing between each pore which does not contain the electrolyte, a normalized Li⁺ concentration, which was measured at 100 nm below the separator region, represented non-uniform distribution at the bottom of the PP separator. The normalized Li⁺ concentration distribution is shown in the inset of FIG. 2(b) (PP|Li line). The result implies the non-uniform Li deposition on the 2D Li anode and thus promotes dendrite growth. On the contrary, in the case of the SE|Li, the normalized Li⁺ concentration was more uniform and had low fluctuation compared to PP|Li case (SE|Li line in the inset of FIG. 2(b)). This is attributed to the effect that Li⁺ migrated through the non-uniform pores of the PP separator to become homogenized while passing through the 3D conducting pathways of the LLZTO arrays in the SE composite membrane. It is well known that the topological characteristics of garnet-type LLZTO, such as sufficient Li⁺ transport pathways through the grain boundaries and the crystal structures give rise to this Li⁺ re-distribution effect. Several previous studies have demonstrated that the grain boundaries with ion migration barriers and different Li⁺ conduction characteristics can affect Li⁺ transport heterogeneity of the solid-state electrolyte. However, the length scales associated with grain boundaries are much smaller than the pores of conventional separators. Thus, atomistic-scale ion transport heterogeneity was not considered in this work. Consequently, applying the SE separator results in less fluctuation of the normalized concentration. Normalized Li⁺ concentration with a small gradient implies more uniform Li⁺ flux near the anode surface and thus, uniform Li deposition compared to the PP separator. Moreover, the corrugated-shaped CNT domain which has a 0.2 μm interval was designed for PP|CNT and SE|CNT pairs to simulate the large surface area compared to the plane Li anode. Several previous studies have investigated that the use of 3D anode framework with a large surface area guides uniform Li plating on its surface due to the local current density mitigation effect in the vicinity of the anode surface. By applying a large surface area CNT anode rather than plane Li anode, PP|CNT had significantly mitigated fluctuation of the normalized Li⁺ concentration caused by the non-uniform pores of the PP separator (PP|CNT line in the inset of FIG. 2(b)). The standard deviation of Li⁺ concentration decreased to one order of magnitude by exploiting the CNT anode. According to this, we hypothesized that if the abundant 3D Li⁺ migration pathways of the SE separator and the Li⁺ concentration distribution homogenization effect of the 3D CNT anode are applied together, it can be anticipated to obtain a more improved Li⁺ re-distribution effect. As a result, SE|CNT represented the most uniform normalized Li⁺ concentration (SE|CNT line in the inset of FIG. 2(b)) and the lowest standard deviation through the whole cases, which well agrees with the hypothesis. The standard deviation results of each separator|anode pair are summarized in Table 1.

TABLE 1
Standard deviation results of the Li⁺ concentration
beneath the separator for each separator/anode pair. Each
calculation was conducted under 1 μm of the separator boundary.

| Separator\|Anode | PP\|Li | SEI\|Li | PP\|CNT | SE\|CNT |
|---|---|---|---|---|
| Standard deviation of Li⁺ | 1.15E−2 | 7.95E−3 | 1.45E−3 | 1.29E−4 |
| concentration [M] | | | | |

According to the simulation results, both stable cycling life and superior performance can be expected by utilizing the synergistic effect between the SE composite separator and 3D CNT anode of the proposed Li metal battery in this work. FEA simulation results proposed in this work are only meaningful in predicting the ideal Li⁺ transfer mechanism for each separator-anode pair (e.g., PP|Li, PP|CNT, SE|Li, and SE|CNT). Specifically, to conduct a comparative analysis of the Li⁺ migration profile under the presence of the nanoporous structure of SE separator, Nernst-Planck equations without considering Faradaic reaction was applied as a governing equation. The Nernst-Planck-Poisson equation may better simulate both Li⁺ migration propensity and Li plating kinetics at the anode surface as it describes both Li⁺ transport and electrochemical reaction. The results observed in actual practical cycling cases may differ from the simulation results. Nevertheless, by conducting these fundamental numerical simulations, we were able to theoretically predict and analyze the difference in the Li⁺ distribution effect for each pair and perform experimental validation.

Based on the simulation analysis for the synergistic effect of the SE|CNT pair under ideal conditions, the following experimental results were investigated to analyze the improved performance under practical conditions. Mechanical flexibility of fully-dried composite films containing 50-wt. % LLZTO and 50-wt. % PVDF-HFP with a thickness of 15 μm was tested. The composite films were able to fold and twist significantly without issue. A cross-sectional image of the film revealed that the film is highly porous (˜80% porosity) and LLZTO particles of several hundred nanometers in size are uniformly distributed. When the composite film was integrated with the CNT anode, the large contact area between the polymer and CNT provides strong adhesion that prevents delamination. The continuous 3D nanopores effectively disperse Li⁺ transport, unlike the conventional PP separators, where Li⁺ funnels through relatively large pores with low porosity (typically <50%). The top surface of our composite film showed LLZTO particles are embedded into the film and the pores are too small to be clearly seen on the top surface, unlike the PP separator. LLZTO allows for Li⁺ conduction through the percolated networks of LLZTO particles, furthering the distribution of Li⁺ in the composite layer, which is advantageous over other metal oxides (e.g., Al₂O₃, TiO₂, SnO₂, etc.). According to X-ray diffraction (XRD) pattern, all the peaks corresponding to LLZTO were maintained when LLZTO was made into composites with PVDF-HFP, suggesting the properties of LLZTO are well retained. Fourier transform infrared radiation (FTIR) results indicated the addition of LLZTO into PVDF-HFP decreased the crystallinity of PVDF-HFP, which can improve the ionic conductivity of the composite.

We first identified a suitable concentration of LLZTO in the composite by characterizing the ionic conductivities (o) of the LLZTO composites on PP separators. The bulk resistance values in the electrochemical impedance spectroscopy (EIS) measurement (the intercept of x-axis in the inset of FIG. 2d) using a symmetric cell configuration with stainless steel (SS) current collectors were used to find the conductivities with geometrical parameters (Table 2) using Eq. 1.

TABLE 2
Separator properties and ionic conductivity (σ).

| | Thickness | Area | Bulk impedance | Ionic conductivity |
|---|---|---|---|---|
| Material | [μm] | [cm²] | (R_{b}) [Ω] | (σ) [mS cm⁻¹] |
| PP | 25 | 1.89 | 2.45 | 0.54 |
| SE15 | 45 | 1.58 | 2.48 | 1.15 |
| SE35 | 45 | 1.44 | 2.05 | 1.53 |
| SE50 | 45 | 1.32 | 2.00 | 1.70 |
| SE75 | 45 | 1.99 | 2.76 | 0.82 |

The highest conductivity (1.7 mS cm⁻¹) was measured at 50 wt. % LLZTO, which is about 3 times higher than that of the PP separator (0.54 mS cm⁻¹). Interestingly, the conductivity was raised with LLZTO contents up to 50 wt. %, and then dropped at 75 wt. %. In our composites, lithium ions can conduct through both percolated solid-state electrolytes and pores where liquid electrolyte was filled up. An increase of SE wt. % can augment percolated SE networks as long as the SE concentration is moderate. However, when the SE wt. % is too high, the SE particles tend to aggregate due to the higher viscosity of the SE/polymer mixture solution. Then the aggregated SE reduces the contact area between SE particles and thereby suppresses Li⁺ transport. Therefore, 50 wt. % LLZTO was selected for further experiments although there may be room for further improvement in the conductivity with a variety of blending ratios of LLZTO to PVDF-HFP. In some aspects, LLZTO may be used in amounts between 40-99 wt. %.

Another important parameter as a measure of Li⁺ transport through the SE composite layer is the Li⁺ transference number (t_{Li+}) (see Eq. 2), which was obtained from the two x-intercepts of the semicircles of EIS before and after chronoamperometry polarization using the symmetric cell configuration with Li metal electrodes. The t_{Li+} of the 50 wt. % LLZTO composite on the PP separator was found to be 0.68, which is about 31% higher than t_{Li+} without the composite (only the PP separator). According to Sand's time model, the higher t_{Li+} of our SE composite layer can be realized as promoting uniform Li plating on the anode. The increase of t_{Li+} could be attributed to the following two aspects—Li⁺ transport paths through the SE networks which Li⁺ can selectively pass through and the negative zeta potential of LLZTO^{55,56} which can facilitate Li⁺ diffusion over anions such as PF₆⁻ and DFOB⁻. In addition, the oxidation stability of the composite (50 wt % LLZTO) on the PP separator was measured to be high (˜4.9 V vs. Li⁺/Li) enough to be compatible with the high nickel cathodes such as Li|Ni_{0.8}Mn_{0.1}Co_{0.1}|O₂ (NMC811) according to the linear sweep voltammetry (LSV) at 5 mV/s scan rate.

The actual Li plating/stripping behaviors were analyzed when our SE composite separator was used in symmetric cells with Li metal foils as electrodes. All the following tests were carried out with 50 wt. % LLZTO for our SE composite unless otherwise noted. The surface morphologies of the Li metal anodes before and after cycling (100 and 200 hours) at a current density of 1 mA cm⁻² and a capacity of 2 mAh cm⁻² were inspected when our SE composite separator was employed (Li|SE|Li cell) in comparison to a conventional PP separator (Li|PP|Li cell). Cycling over 100 hours did not noticeably alter the Li metal surface of Li|SE|Li in contrast to the non-uniformly distributed branch-like dendrites from Li|PP|Li. After 200 hours of cycling, the dendrites on Li|PP|Li noticeably grew whereas Li|SE|Li maintained a uniform and dense surface morphology. These features were manifested in the cross-sectional views showing a dense and thin layer from Li|SE|Li and a porous and thick layer from Li|PP|Li on the Li foils. The uniform Li plating/stripping is ascribed to delocalized Li⁺ flux through the SE layer, but, in Li|PP|Li, the Li⁺ flux through the pores of the conventional PP separator is concentrated, accelerating dendrite nucleation and growth.

The Li homogenization effect with the SE composite was further validated using in-operando studies by plating Li on a Cu current collector at a high current density of 4 mA cm 2 and a capacity of 4 mAh cm⁻², as displayed in for Li|SE|Cu and for Li|PP|Cu asymmetric cells (see SI for the operando cell test). As to the Li|SE|Cu cell, even under a high current density (4 mA cm⁻²), the morphology variations of plated Li on the Cu current collector were hardly noticed throughout the entire plating (60 min). In contrast, the Li|PP|Cu cell localized Li plating, and then dendrites (see the spot indicated by the arrow) rapidly grew as a result of preferential Li deposition on the dendrites. The dendrite after 4 mAh cm⁻² Li plating was too large to be within the depth of focus. Interestingly, the Li metal surface of Li|PP|Cu became very rough, evidently demonstrating that Li⁺ flux through the PP separator was non-uniform and detrimental during Li plating and stripping.

The compositional variations as a result of delocalizing Li⁺ flux were comparatively investigated by X-ray photoemission spectroscopy (XPS) of Li metal surfaces after 100-hour operation of Li|SE|Li and Li|PP|Li symmetric cells. During the cycling, solid electrolyte interphase (SEI) layers were formed and their F 1s, O 1s, and C 1s peaks were evaluated. We noticed that the areal ratio corresponding to the Li—F peak (684.8 eV) in F 1s from the Li|SE|Li cell was larger (˜48%) than that of the Li|PP|Li cell (˜33%). The LiF-rich SEI layer was found to promote uniform Li plating and suppress the corrosion of Li because it has outstanding physiochemical stability owing to the high Young's modulus (64.9 GPa). Another stable component, Li₂CO₃ (531.8 eV) from O 1s in the SEI layer of Li|SE|Li (˜79%) was more abundant than that of Li|PP|Li (˜54%). It is known that the lithium difluoro (oxalato) borate (LiDFOB) additive in the carbonate-ester-electrolyte used in this work boosts stable inorganic components (e.g., LiF, Li₂CO₃) in the SEI layer. In addition, the areal ratio of polycarbonate (poly(CO₃) in C 1s at 290.0 eV), which suppresses the swelling of Li during plating/stripping, was measured to be higher (˜49%) for Li|SE|Li compared with Li|PP|Li (˜39%), suggesting the delocalization of Li⁺ flux and high Li⁺ transference number are crucial in forming stable SEI layers.

In the same vein, the areal ratio corresponding to LiₓPO_{y}F_{z} in F 1s (686.5 eV), which is attributed to the undesirable decomposition of LiPF₆ salt, was found to be lower (˜28%) in Li|SE|Li than that of Li|PP|Li (˜51%). The result is consistent with that the areal ratio of C—F bonding in F 1s (686.9 eV), which is attributed to the decomposition of fluoroethylene carbonate, was found to be higher (˜24%) in Li|SE|Li compared to the Li|PP|Li (˜16%). Another unwanted byproduct, (CH₂—CH₂—O)ₙ (533.5 eV)⁷² from the decomposition of carbonate electrolyte lessened with the SE layer (˜22%) compared to ˜46% with only the PP separator. Moreover, the total organic components in the Li|SE|Li cell is ˜51% (45% for C—O at 286.4 eV and 6% for C═O at 288.4 eV), which is ˜10% lower than that of the Li|PP|Li cell (˜61%). The aforementioned XPS analyses indicate that the SE layer made it possible to create more stable SEI layers, which have impeded dendrite growth owing to the delocalized Li⁺ conduction.

Although the uniform Li⁺ flux can delay the dendrite growth on the 2D Li metal anode, the limited surface area of 2D Li metal intrinsically makes it difficult to eradicate the problems during the cycling process. Here we further studied the effects of having a 3D host framework as a Li metal anode, which can induce even more uniform Li plating and further suppress dendrite growth. In particular, the nanostructured 3D CNT framework offers large specific surface areas that lower the local current density, regulating the substantial volume change of Li metal in the anode during Li plating/stripping. Here, we utilized previously reported functionalized unzipped CNT structures which was fabricated by opening C—C bond with the formation of manganate ester due to the lower bonding energy between MnO₄⁻¹ anion and carbon. The partially unzipped trench CNT have hybridized lithiophobic/philic surfaces by attaching carboxyl (—COOH) functional groups to the cleaved CNT surfaces,⁸² which offer an extremely large capacity (˜16 mAh cm⁻²) at a high current density (8 mA cm⁻²) without dendrite formation. The large interfacial surface area of 3D CNT anode with additionally unzipped trench structure induced strong adhesion between SE composite and 3D CNT anode.

The effects of employing CNT were evaluated by assessing the galvanostatic voltage profiles during Li plating and EIS measurement results at 5 mV after Li stripping from the CNT electrode for Li|PP|CNT, and Li|PP|Cu asymmetric cells. As witnessed in the in-operando study, the Li|PP|Cu cell showed high nucleation overpotential (ηₙᵤ ˜95 mV), which can be calculated as the difference between the tip overpotential (ηₜᵢₚ ˜125 mV) and the converged mass-transfer controlled overpotential (η_{mtc} ˜30 mV). When the amount of Li deposition exceeded 13 mAh cm⁻², a gradual increase in η_{mtc} occurred, and after 30 mAh cm⁻² of Li deposition, a drastic increase in the overpotential was observed. The large overpotential and unstable voltage profile of the Li|PP|Cu cell denote the non-uniformly deposited Li on the Cu surface. On the contrary, it is clearly seen that ηₙᵤ (˜15 mV) from Li|PP|CNT was much smaller than Li|PP|Cu. The voltage dropped as lithiation progressed, and then became negative, indicating lithium metal was plated into the pores of the 3D CNT framework beyond lithiation. Despite the large amount of Li insertion (˜35 mAh cm⁻²) into the CNT, η_{mtc} was maintained at ˜21 mV, showing stable ηₙᵤ values. The stable voltage profile of the Li|PP|CNT cell can be attributed to the uniformly deposited Li because the carboxyl group attached to the partially unzipped CNT surface can attract Li⁺, unlike pristine graphitic carbon. The reduced current density with the CNT electrode was confirmed by the EIS results of Li|PP|CNT in comparison to Li|PP|Cu asymmetric cells. The diameter of the semicircle denotes impedance associated with charge transfer at the surface of the electrode. The impedance of Li|PP|CNT was measured to be ˜5Ω, which is only ˜5% compared to that of Li|PP|Cu (˜101Ω).

As the CNT in the Li|PP|CNT cell facilitated uniform Li plating on the CNT anode, we carried out long-term testing of our SE composite separator (Li|SE|CNT asymmetric cell) along with a Li|PP|Li cell for comparison. The galvanostatic cycling stability tests were conducted with a capacity of 2 mAh cm⁻² at 0.5 mA cm⁻², 1 mA cm⁻², and 2 mA cm⁻². The overpotentials during plating/stripping of Li into/from CNT at 0.5 mA cm⁻² were ˜13 mV over ˜800 hours (˜100 cycles) and then the stripping overpotential was slightly enlarged to 0.1 V and maintained over 2800 hours. The stripped-to-plated lithium metal ratio for Li|SE|CNT was maintained to be ˜98%, which supports the stable plating/stripping behavior of the SE|CNT pair compared to PP|Li. In contrast, the voltage profile of the Li|PP|Li cell was unstable, showing large overpotentials at only ˜500 hours of operation (˜60 cycles) with significant decay in CE. A higher current density of 1 mA cm⁻² did not noticeably alter the Li plating/stripping behaviors of Li|SE|CNT while the cycling lifetime of Li|PP|Li was considerably shortened. The superior cycling stability of Li|SE|CNT compared to Li|PP|Li is indicative of the synergistic effect from the SE layer and 3D CNT host framework. The delocalized Li⁺ flux through the SE layer facilitates homogeneous Li plating, and the large surface area of CNT lowers the areal current density and thereby promotes uniform Li plating/stripping, reducing charge transfer impedance and dendrite formation.

To validate the practical applicability of the SE layer and 3D Li-deposited CNT anode, full cell tests with the most representative metal oxide-based cathodes, NMC811 and LiFePO₄ (LFP) in Li-ion batteries were carried out. All tests were conducted after initial SEI-formation cycles (3 cycles at 0.1 C where 1 C=200 mA g⁻¹ for NMC811 and 1 C=170 mA g⁻¹ for LFP). Specific capacity (mAhg⁻¹) vs cycles was tested and showed cycling performances at 1 mA cm⁻² (0.5 C) when NMC811 (active material loading of ˜12.1 mg cm⁻²) was coupled with a SE/CNT (separator/anode) pair, a PP/CNT pair, and a PP/Li pair with the charge/discharge voltage window of 2.8˜4.3 V. For NMC811|SE|CNT cell (red diamonds), the initial discharge capacity was ˜179 mAh g⁻¹ and gradually increased to 192 mAh g⁻¹ at the 40^{th} cycle, presumably due to the initial activation of the SE layer. After this cycle, the capacity fading was only ˜0.19 mAh g⁻¹ (˜0.1%) per cycle with excellent average CE (˜99.8%), and 80% of capacity retention with respect to the initial capacity was marked at the 235th cycle. When the PP and Li metal foil (NMC811|PP|Li, green triangles) were used, the capacity rapidly decayed, showing 80% of the capacity retention (149 mAh g⁻¹) with respect to the initial discharge capacity (186 mAh g⁻¹) only at the 35th cycle. Large increases in the cell overpotential and CE fluctuation were observed in the following cycles, and eventually, the capacity became almost zero at the 150^{th} cycle. The limited surface area on the 2D Li metal anode and localized Li⁺ flux would be responsible for the poor cycling performances, as corroborated by non-uniform dendrites and dead lithium on the anode.

When 2D Li metal was replaced by CNT without the SE layer (NMC811|PP|CNT), the cycling number at 80% capacity retention was prolonged from 35 to 80, but rapid capacity fading in the subsequent cycles was unavoidable. The extended cycling stability would be the benefit from the reduced current density on the CNT surface. Nevertheless, the localized Li⁺ flux through the PP separator gradually formed Li dendrites during repeated Li plating/stripping. Specific capacity (mAhg⁻¹) vs cycles was tested and showed the rate capability comparison between NMC811|SE|CNT and NMC811|PP|Li. The average capacity data for each current density of the two cells are summarized in Table 3.

TABLE 3
The average capacity values of the NMC811|SE|CNT
and NMC811|PP|Li full cells.

| | Average discharge capacity of | Average discharge capacity of |
|---|---|---|
| Current density (Cycle) | NMC811\|SE\|CNT (mAh g⁻¹) | NMC811\|PP\|Li (mAh g⁻¹) |
| 40 mA g⁻¹ (1^{st}-5^{th}) | 202.6 | 204.1 |
| 60 mA g⁻¹ (6^{th}-10^{th}) | 196.9 | 198.9 |
| 100 mA g⁻¹ (11^{th}-15^{th}) | 186.6 | 178.0 |
| 200 mA g⁻¹ (16^{th}-20^{th}) | 166.1 | 159.5 |
| 400 mA g⁻¹ (21^{st}-25^{th}) | 142.3 | 120.3 |
| 200 mA g⁻¹ (26^{th}-30^{th}) | 168.6 | 158.3 |
| 100 mA g⁻¹ (31^{st}-35^{th}) | 185.2 | 184.8 |
| 60 mA g⁻¹ (36^{th}-40^{th}) | 195.2 | 195.2 |
| 40 mA g⁻¹ (41^{st}-45^{th}) | 201.0 | 200.3 |

The average discharge capacity between the two cases shows a small difference under the low C-rate conditions (0.2 C, 0.3 C, and 0.5 C). However, at the high C-rate conditions (1.0 C and 2.0 C), NMC811|SE|CNT demonstrated 6.5% (for 1.0 C) and 18.3% (for 2.0° C.) higher average capacity results than NMC811|PP|Li. The higher rate capability of the NMC811|SE|CNT cell can be attributed to the influence of the high t_{Li+} of the SE composite separator and the reduced local current density effect from the CNT anode.

Additionally, the synergistic effect of SE composites and CNT anodes were further verified under practical conditions seeking high energy densities with high loading NMC811 cathodes (4 mAh cm⁻², active material loading of ˜21 mg cm⁻²) with a low N/P ratio (2.5) condition. Three different types of separator/anode pairs (NMC811|SE|CNT, NMC811|PP|CNT, and NMC811|PP|Li) were comparatively tested. The NMC811|SE|CNT full cell has shown an outstanding maximum capacity (204 mAh g⁻¹) at the 40th cycle despite a high current density (1.2 mAh cm⁻²) as well as ˜81% capacity retention with respect to the initial capacity (193 mAh g⁻¹) at the 200th cycle. Contrariwise, the NMC811|PP|CNT and NMC811|PP|Li cells had 80% capacity retention only at the 113th and 117th cycle, respectively. Compared to the NMC811|SE|CNT cell, both the NMC811|PP|CNT and the NMC811|PP|Li cell showed rapid capacity fading and unstable cycling performances, which are consistent with the trend shown in test results (cathode capacity of 2 mAh cm⁻²).

The CNT anodes of NMC811|SE|CNT and NMC811|PP|CNT at the 100th fully discharged state were inspected under SEM. The surface of the anode facing the separator had a flat surface without noticeable dendrites over the surface. A lower portion exhibited hairy CNT features and pores. The SE layer can distribute Li⁺ flux so Li was inserted into the pores without considerably plating Li metal on the top surface. The hairy CNTs were well integrated into the SE layer, eliminating spaces for dendrite growth between the separator and CNT anode. On the contrary, the cross-section of the anode revealed that porous dendrites were formed over the CNT electrode, clearly depicting the role of the SE layer. The localized Li⁺ flux through the PP separator eventually clogged the pores of the anode surface and ended up with porous dendrites after repeated Li plating/stripping. The concentrated Li⁺ through the PP separator can be readily plated in the gap between the separator and anode, and displayed a porous and uneven anode surface. After clogging the pores of the CNT framework, the anode acts like a typical 2D Li surface without utilizing the inner pores. These experimental outcomes highlight the synergistic integration of our SE separator and CNT electrode, which can augment the cycling performance of the Li batteries.

The comparative analysis of the EIS measurement results at the fully-discharged 10th, 50th, and 100th cycle for NMC811|SE|CNT, NMC811|PP|CNT, and NMC811|PP|Li further unveiled the effects of the SE layer (vs. PP) and CNT framework (vs. 2D Li metal) are shown in Tables 4-6.

TABLE 4
The bulk impedance data of the NMC811|SE|CNT,
NMC811|PP|CNT, and NMC811|PP|Li full cells at the
10^{th}, 50^{th}, and 100^{th} cycles.

| | Type | | |
|---|---|---|---|
| | R_{b} (Ω) | R_{b} (Ω) | R_{b} (Ω) |
| Cycle | (NMC811\|SE\|CNT) | (NMC811\|PP\|CNT) | (NMC811\|PP\|Li) |
| 10^{th} | 3.4 | 3.8 | 7.5 |
| 50^{th} | 3.3 | 3.9 | 7.9 |
| 100^{th} | 3.8 | 5.2 | 11.5 |

TABLE 5
The interfacial contact impedance data of the NMC811|SE|CNT,
NMC811|PP|CNT, and NMC811|PP|Li full cells at the
10^{th}, 50^{th}, and 100^{th} cycles.

| | Type | | |
|---|---|---|---|
| | R_{c} (Ω) | R_{c} (Ω) | R_{c} (Ω) |
| Cycle | (NMC811\|SE\|CNT) | (NMC811\|PP\|CNT) | (NMC811\|PP\|Li) |
| 10^{th} | 33.4 | 51.1 | 146.1 |
| 50^{th} | 44.3 | 72.9 | 136.1 |
| 100^{th} | 55.5 | 93.9 | 162.2 |

TABLE 6
The charge-transfer impedance data of the NMC811|SE|CNT,
NMC811|PP|CNT, and NMC811|PP|Li full cells at the
10^{th}, 50^{th}, and 100^{th} cycles.

| | Type | | |
|---|---|---|---|
| | R_{ct} (Ω) | R_{ct} (Ω) | R_{ct} (Ω) |
| Cycle | (NMC811\|SE\|CNT) | (NMC811\|PP\|CNT) | (NMC811\|PP\|Li) |
| 10^{th} | 62.7 | 51.7 | 89.9 |
| 50^{th} | 59.9 | 75.8 | 114.2 |
| 100^{th} | 83.2 | 111.2 | 144.0 |

The equivalent circuit for EIS fitting consists of bulk impedance (R_{b}), the interfacial contact impedance at the SEI layer (R_{c}), and the charge transfer impedance at the electrolyte/electrode interface (R_{ct}). The impedance values of NMC811|SE|CNT were kept low compared to the other cells, validating the synergistic effect from the SE layer and CNT framework. It is remarkable that R_{c} with CNT was much lower than 2D Li metal even without the SE layer, which elucidates the effectiveness of Li plating/stripping over large surface areas. Moreover, Ret of NMC811|PP|Li was considerably raised at the 100th cycle although all the R_{ct} values at the 10th cycle were relatively close to each other. This would suggest the formation of dead Li on the porous Li metal anode as it impedes charge transfer at the electrolyte/electrode interface.

To identify the long-term stability of our composite and CNT pair, another set of full cells with LFP cathodes (active material loading ˜7.3 mg cm⁻²) were examined because LFP is known to be more long-lasting than NMC811. This experimental set does not only avoid cathode-limited performances, but also verify the compatibility of our separator/anode pair with another popular cathode. Testing cycling performances at 0.5 C (0.63 mA cm⁻²) with a potential window of 2.5˜4.1 V showed LFP|SE|CNT had high capacity retention with respect to the initial capacity of 152 mAh g⁻¹, exhibiting ˜80% at the 750th cycle and a high average CE of ˜99.7% as well as ˜70% at the 1300th cycle. In contrast, LFP|PP|Li displayed drastic capacity drop accompanied by large fluctuation in CE with ˜80% capacity retention (with respect to the initial capacity of 148 mAh g⁻¹) only at the 160th cycle. When CNT replaced 2D Li metal (LFP|PP|CNT cell), the capacity retention was more or less improved (˜80% at ˜200th cycle with ˜99.9% CE), but this cell suddenly failed to cycle at the 260th cycle. It is worth noting that the PP|Li and PP|CNT pairs showed substantially enlarged overpotentials as cycled according to the charge/discharge voltage profiles of the NMC and LFP full cells. As the cycles neared the failure, the charge/discharge curves eventually became unsteady. The enlarged overpotentials for both charge and discharge imply that irreversible products such as dead Li covered the surface of the anode, inhibiting Li⁺ transport between the cathode and anode. Conversely, the SE|CNT pairs yielded stable voltage profiles near the PP|CNT and PP|Li failure. Our observation suggests that the pores in the porous scaffolds are easily clogged over repeated non-uniform Li plating/stripping, which makes such porous structures eventually similar to 2D Li metal without the SE layer. The rate capability test results of the LFP full cells with the SE|CNT pair are also superior to the PP|Li counterpart particularly under high C-rate conditions. The average capacity data corresponding to the C-rates (current density) are arranged in Table 7.

TABLE 7
The average capacity values of the LFP|SE|CNT and LFP|PP|Li full cells.

| | Average discharge capacity of | Average discharge capacity of |
|---|---|---|
| Current density (Cycle) | LFP\|SE\|CNT (mAh g⁻¹) | LFP\|PP\|Li (mAh g⁻¹) |
| 34 mA g⁻¹ (1^{st}-5^{th}) | 162.8 | 161.0 |
| 51 mA g⁻¹ (6^{th}-10^{th}) | 157.2 | 149.5 |
| 85 mA g⁻¹ (11^{th}-15^{th}) | 148.4 | 136.1 |
| 170 mA g⁻¹ (16^{th}-20^{th}) | 131.9 | 103.2 |
| 340 mA g⁻¹ (21^{st}-25^{th}) | 82.3 | 59.7 |
| 170 mA g⁻¹ (26^{th}-30^{th}) | 129.3 | 97.9 |
| 85 mA g⁻¹ (31^{st}-35^{th}) | 144.0 | 125.0 |
| 51 mA g⁻¹ (36^{th}-40^{th}) | 152.9 | 130.4 |
| 34 mA g⁻¹ (41^{st}-45^{th}) | 157.0 | 156.6 |

In addition to the NMC811 full cell test, the LFP test results elucidated the versatility of the SE composite separator and CNT anode with outstanding cycling performances.

According to the Li dendrite growth model derived from the Volmer-Weber theory, 3D substrates with large surface areas and induce smooth Li plating compared to plain surfaces. Another study has investigated the correlation between the surface energy stabilization effect by exploiting linear stability computational simulation. According to previous studies, the surface energy of 3D porous anodes is crucial in Li metal plating/stripping. For example, our previous studies elucidated pristine graphitic surfaces on CNT are lithiophobic, which is disadvantageous in Li plating. On the other hand, lithiophilic carboxyl/hydroxyl functional groups on the graphitic surface of CNT can readily attract and diffuse Li⁺ into the porous structure of the 3D CNT. However, the Li⁺ affinity of the functional groups provoked pore clogging at the inlet (between the anode and separator) and eventually dendrite growth along with the inferior charge transfer compared to pristine graphitic surfaces. To mitigate this problem, mechano-chemical treatments partially creating lithiophilic functional groups along the unzipped graphitic carbon surfaces were exploited. The favorable charge transfer of the preserved graphitic layer and presence of the lithiophilic functional groups allows for the intercalation and uniform deposition of Li on the CNT. Here, we have utilized the lithiophilic/lithiophobic hybridized CNTs as our 3D framework to have the uniform Li metal plating, which was validated by our experimental results such as low impedance results of Li|PP|CNT compared to Li|PP|Cu, smooth CNT anode surface without dendrites after 100th cycle, and EIS results of SE|CNT paired with NMC811 cathode.

The gravimetric and volumetric energy densities of the NMC811|SE|CNT full cell were obtained, and the maximum gravimetric energy densities were compared with those of popular commercial cells based on NMC cathodes. The energy density values were attained by considering the mass and volume the cathode, anode, separator, electrolyte, and current collectors (typical thicknesses of Al and Cu) except outer housing/case (see SI for more details about energy density calculation). The energy density values of the commercial cells (Table 8) were calculated based on the available performance data (e.g., specific energy (Wh kg⁻¹), capacity (Ah), and working voltage (V)) and the weight fraction of the cell components. The NMC811|SE|CNT cell exhibited 334 Wh kg⁻¹ and 783 Wh L⁻¹ and the capacity retention was 89% at 140th cycle even under practical conditions (N/P ratio 2.5, 4.3 g Ah⁻¹ of the electrolyte).

TABLE 8
Detailed information of the commercial Li-ion batteries along with our NMC811|SE|CNT
full cell under the lean electrolyte condition. The 5^{th} column describes the specific
energy density values in the literature. The 6^{th} column represents the calculated
specific energy density values excluding the external housing/case. In the rightmost
column, the number in the bracket is the initial production year.

| | | | | Gravimetric | Gravimetric | | |
|---|---|---|---|---|---|---|---|
| | | | | energy | energy | | |
| | | | Dis- | density | density | Volumetric | |
| | | | charge | (literature | excluding | energy | Manufacturer/ |
| | | | voltage | data) | housing/case | density | Model |
| Label | Cathode | Anode | (V) | (Wh kg⁻¹) | (Wh kg⁻¹) | (Wh L⁻¹) | (Year) |
| This | NMC | CNT | 3.85 | — | 334 | 783 | — |
| work | | | | | | | |
| LG1 | NMC | Graphite | 3.65 | 241 | 290 | 466 | LG chem./ |
| | | | | | | | Renault Zoe |
| | | | | | | | (2017) |
| LG2 | NMC | Graphite | 3.7 | 186 | 224 | 393 | LG chem./ |
| | | | | | | | Chevrolet Bolt |
| | | | | | | | (2016) |
| LT | NMC | Graphite | 3.65 | 152 | 183 | 316 | Li-Tec/Smart |
| | | | | | | | Fortwo EV |
| | | | | | | | (2013) |
| PS | NMC | Graphite | 3.7 | 130 | 157 | 215 | Panasonic- |
| | | | | | | | Sanyo/ |
| | | | | | | | VW e-Golf |
| | | | | | | | (2015) |
| S | LMO- | Graphite | 3.65 | 172 | 207 | 312 | Samsung SDI/ |
| | NMC | | | | | | Fiat 500e |
| | | | | | | | (2013) |
| LG3 | LMO- | Graphite | 3.75 | 157 | 189 | 275 | LG chem./ |
| | NMC | | | | | | Renault Zoe |
| | | | | | | | (2012) |
| J | LMO- | Graphite | 3.7 | 109 | 131 | 218 | Li Energy |
| | NMC | | | | | | Japan/ |
| | | | | | | | Mitsubishi i- |
| | | | | | | | MIEV (2008) |

The gravimetric and volumetric energy densities are superior to those of commercial cells whose cathodes are made of NMC or NMC with lithium manganese oxide (LMO) along with graphite anodes. Furthermore, the cell-level energy densities of our NMC811|SE|CNT full cell are within the target range when Li metal anode is coupled with NMC cathodes. This implies that the synergistic effect from our composite separator and CNT host anode would be a potential solution for utilizing Li metal as an anode. The XPS analyses of the anode of NMC811|SE|CNT in comparison to those of NMC811|PP|CNT suggest the superior performances of our full cell could be attributed mainly to the delocalization of Li⁺ plating/stripping on the anode side according to O 1s and C 1s spectra at the 100th fully discharged state of the full cells. We found that a stable inorganic component, Li₂CO₃ at 531.8 eV (O 1s) was higher in NMC811|SE|CNT (areal ratio: 47.9%) compared to NMC811|PP|CNT (24.5%). Furthermore, an unstable organic component, C═O at 288.4 eV (C 1s) was lower in the SE cell (7.6%) than PP (33.9%).

### CONCLUSION

This work presents a feasible route of utilizing Li metal as an anode, which is considered to be the most practical option without altering the cathode and electrolyte of the current commercial Li-ion batteries. Li metal anode could offer the highest energy density for conventional Li-ion batteries as long as the detrimental side effects such as severe capacity fading and Li dendrite formation can be mitigated. Here we have identified the main failure mechanism when Li metal was substituted for the graphite anode of typical Li-ion batteries. When Li⁺ flux passes through the limited pores of the conventional PP separator, Li⁺ is inhomogeneously distributed, facilitating preferential Li plating and thereby promoting dendrite growth. Our new composite separator consisting of SE (LLZTO) particles and polymer (PVDF-HFP) can provide numerous Li⁺ passages through the percolated SE and pore networks and thereby deliver delocalized Li⁺ to the anode. FEA simulation results for PP|Li and SE|Li theoretically confirmed that a more uniform Li⁺ concentration distribution was formed when the SE composite separator was utilized compared to the conventional PP separator. In addition, our composite separator has a higher conductivity and Li⁺ transference number than the PP separator. The in-operando and microscopy results revealed that the Li|SE|Li cell shows more uniformly distributed and compact Li metal surfaces after cycling compared with those of the Li|PP|Li cell. The XPS results also displayed that the robust and stable inorganic-rich SEI layer was formed on the Li anode by adopting SE and CNT according to the areal ratios of the Li—F and the Li₂CO₃ peaks.

Li metal anode is also fatal when the SEI layer frequently breaks as a result of large volume changes over the limited 2D Li metal surface because porous Li layer and Li consumption are accompanied. Our 3D CNT framework anode furnished large surface areas significantly reducing the current density and the volume change during Li plating/stripping. Through the FEA simulation, the SE|CNT case showed the lowest standard deviation of Li⁺ near the anode through all separator|anode pairs, which implies a superior Li⁺ homogenization effect and thus, uniform Li plating behavior. The galvanostatic cell overpotential profiles and EIS data showed that the SE|CNT pair has a smaller nucleation overpotential (˜15 mV) and contact impedance (˜5 (2) compared to those of the PP|Li pair, suggesting more uniform Li plating on the 3D CNT. Besides, the Li|SE|CNT asymmetric cell retained low cell overpotentials and a high average CE over the ˜2800 hours of cycling. It should be pointed out that the stable operation of Li metal was observed only when both the SE and CNT were paired, suggesting the synergistic effect is essential.

Finally, full cell tests with the commercially most popular cathodes were carried out by coupling our SE|CNT pair. The NMC811|SE|CNT full cell showed ˜80% capacity retention with an average CE of ˜99.8% until the 235th cycle whereas NMC811|PP|Li cell experienced rapid capacity fading (˜80% capacity retention at the 35th cycle) with unstable CE. Furthermore, LFP|SE|CNT cell showed superior cycling performances (˜80% capacity retention at 750th cycle) with an average CE of ˜99.8%. According to EIS analysis, NMC811|SE|CNT possessed both low interfacial contact impedance (R_{c}) and charge transfer impedance (R_{ct}) compared to NMC811|PP|Li. The SEM images disclosed smooth anode surfaces for NMC811|SE|CNT in contrast to the dendrite-dominant clogged anode surface of NMC811|PP|CNT. Ultimately, the energy densities (334 Wh kg⁻¹ and 783 Wh L⁻¹) of NMC811|SE|CNT were raised compared to those of commercial Li-ion batteries, suggesting a readily deployable option for exploiting Li metal as an anode.

Reference will now be made to particular materials and methods utilized by various embodiments of the present disclosure. However, it should be noted that the materials and methods presented below is for illustrative purposes only and is not intended to limit the scope of the claimed subject matter in any way.

### Experimental

Highly Stable Lithium Metal Batteries by Delocalizing Lithium Ion Flux with a Solid-State Electrolyte Composite Coupled with a 3D Porous Framework

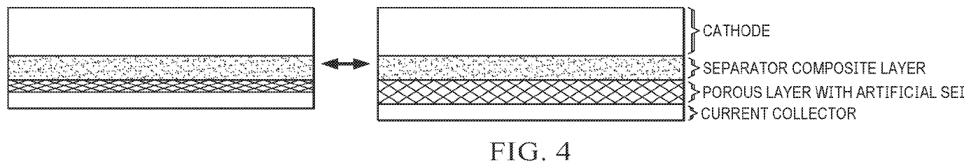

Our novel composite membrane coupled with elastic porous layer is applicable to the all-solid-state and anode-free Li metal batteries in addition to conventional liquid-electrolyte based batteries (see FIG. 4). The separator composite layer is composed of solid-state electrolytes such as Li_{6.4}La₃Zr_{1.4}Ta_{0.6}O₁₂ (LLZTO), Li_{1.5}Al_{0.5}Ti_{1.5}(PO₄)₃ (LATP), Li₆PS₅Cl (Argyrodite), and Li₁₀GeP₂S₁₂ (LGPS) blended with polymers such as poly(ethylene oxide) (PEO), polyimide (PI), polyacrylonitrile (PAN), or poly(vinylidene fluoride-co-hexafluoropropylene (PVDF-HFP). Underneath the separator layer, elastic porous layer accommodates lithium metal. The volume of the elastic porous layer can vary during the charge and discharge processes. This layer consists of elastic materials such as a carbon nanotube (CNT) sponge with an artificial solid electrolyte interphase (SEI) layer composed of Li-rich alloys such as Li₁₃In₃, LiZn, Li₃Bi, or Li₃As. For the all-solid-state batteries, solid-state electrolytes are embedded in the pores. The conceptual illustration is presented in FIG. 4.

The separator layer, which is made of solid electrolytes and polymers, can prevent the localization of Li⁺, which is attributed to the non-uniform pore distribution of conventional separators. Specifically, the negative zeta potential of the solid electrolytes can induce Li⁺ diffusion over anions, which leads to higher Li⁺ transference number. In comparison to a pellet-type solid-state electrolyte composed of the solid electrolyte alone, mechanical properties resisting fractures can be greatly improved by elastic polymers. Consequently, by inducing a homogenized Li⁺ flux compared to the existing system through the percolated SE structure and the uniformly distributed pore network within the upper part, it is possible to achieve uniform Li plating/stripping, and thus outstanding cycling reversibility.

The elastic porous layer, which is mainly composed of CNT structures, provides large surface areas compared to two-dimensional substrates. The local current density can be low enough to mitigate the repeated breakage of the solid electrolyte interphase (SEI) layer. The elastic property can accommodate the volume change of Li during stripping and plating.

The transferred Li⁺ from the cathode to the anode can be plated within the porous layer or/and onto the current collector through the Li-rich alloy layer consisting of LiCl and Li_{y}M_{z} (M=In, Zn, Bi, As) according to lithium alloy generation reaction (Eq. 3) and metal chloride reduction reaction (Eq. 4).

$$y Li + z M \to {Li}_{y} {M}_{z} \qquad ( Eq . 3 )$$

$$x Li + {MCl}_{x} \to M + x LiCl ( M = In , Zn , Bi , As ) \qquad ( Eq . 4 )$$

The alloy phase has a higher Li⁺ diffusion coefficient (10⁻⁸˜10⁻⁶ cm²s⁻¹) than the bulk Li phase (5.7×10⁻¹¹ cm²s⁻¹), which promotes Li⁺ transport through the alloy phase and thus leads to the uniform Li plating/stripping during the cycling, thereby mitigating dendrite formation.

Therefore, according to the synergistic effect between the superior Li⁺ homogenization effect of both the separator composite and the CNT with an artificial SEI layer, a higher energy density and outstanding cycling behaviors can be achieved. The design is applicable not only to systems using Li metal anodes and liquid electrolytes but also to anode-free and all-solid-state battery systems, suggesting a wide range of applications including, but not limited to, electric vehicles and electric airplanes that require high levels of energy density, energy storage systems (ESS).

### Preparation of Solid-State Electrolyte (SE) Composite Separators

The SE composite layer was fabricated using the general blade casting method. First, 0.75 g of poly(vinylidene fluoride-co-hexafluoropropylene (PVDF-HFP) (M_{w}˜400,000, Sigma Aldrich) pellets were dissolved into 4 g of acetone solution, then the mixture was magnetically stirred at 50° C. for 6 hours. Subsequently, 0.16 g of Li_{6.4}La₃Zr_{1.4}Ta_{0.6}O₁₂ (LLZTO) (>99.9%, Ampcera Inc.) powders were dispersed in the 1 g of the mixture solution with the weight ratios (LLZTO:PVDF-HFP) in the main manuscript with continuous stirring for additional 6 hours at room temperature. The final homogeneous slurry of PVDF-HFP and LLZTO was cast on a conventional polypropylene (PP) separator (Celgard 2500, 55% porosity according to the specification) using a doctor blade with a gap height of 50 μm. The membrane was then immediately transferred to a vacuum oven and dried under 30° C. for 12 hours to completely evaporate the solvent. Finally, the fully-dried membrane was punched to have coin shape separators whose diameters are 15.88 mm (⅝ inch).

### Preparation of the 3D Carbon Nanotube (CNT) Framework and Electrode

Cylindrical sponge-like porous CNT frameworks were synthesized by a chemical vapor deposition (CVD) process. The detailed CVD procedure is described in our previous study. The cylindrical CNT was sliced into films (100˜200 μm) using a razor blade. Then, a mechano-chemical treatment of the sliced CNT was carried out using a vacuum filtration set up with a solution composed of KMnO₄ (>99%, AMRESCO) and sulfuric acid (95˜98%, BDH Chemicals). This acid treatment creates trench-walls and carboxyl functional groups on CNT, as explained in our paper. After completing the acid treatment, the sliced CNT films were rinsed with deionized water, and then fully dried under 60° C. for 12 hours. The CNT films were chopped into pieces using a high-energy ball miller (SPEX SamplePrep 8000M Mixer Mill) with a hardened steel container (SPEX SamplePrep 8001) with two chrome steel balls (5 mm diameter, Swordfish). CNT particles whose diameters are a few hundred microns were selectively collected using sieves. The CNT particles were mixed with polyvinylidene fluoride (PVDF, M_{w} ˜534,000, Sigma Aldrich) at a weight ratio (CNT:PVDF) of 95:5 in N-methyl-2-pyrrolidinone (NMP, >99%, Sigma Aldrich) with a solid-to-solvent ratio of 100 mg/mL using a mortar and pestle for 5 minutes. The slurry was coated on a Cu foil using a doctor blade with a gap height of 450 microns, and fully dried in a vacuum oven under 60° C. for 12 hours. The CNT electrode was cut into circular shapes with a diameter of 9.5 mm (⅜ inch).

### Preparation of Li-Deposited CNT Anode

Li|CNT asymmetric cells were assembled using the prepared 3D CNT electrode and Li metal (200 μm in thickness, 99.9%, Alfa Aesar) with a CR2032 coin cell in an Ar-filled glovebox (O₂ <0.5 ppm, H₂O <0.5 ppm). The electrolyte was prepared by dissolving 1.0 M lithium bis(trifluoromethanesulfonyl)imide (LiTFSI) (99.0%, Sigma Aldrich) and 0.5 M lithium nitrate (LiNO)₃) (99.0%, Alfa Aesar) in a mixture of 1,3-dioxolane (DOL) (99+%, Alfa Aesar) and 1,2-dimethoxyethane (DME) (99+%, Alfa Aesar) (volumetric ratio of 1:1). The assembled cell was initially cycled at 0.5 mA cm⁻² with a cutoff voltage window of 0˜2 V for 10 cycles for fully lithiating the CNT. Thereafter, a predetermined amount of Li (6 mAh cm⁻² for CNT anode of the Li metal plating tests, 10 mAh cm⁻² for CNT anode of the NMC811|SE|CNT, NMC811|PP|CNT, LFP|SE|CNT, and LFP|PP|CNT full cells) was plated into the pore of the CNT at 1.0 mA cm⁻² until a predetermined capacity (mAh cm⁻²) and a lower cut-off voltage of −0.5 V. After finishing the first lithium metal deposition process, 10 more stripping/plating cycles were carried out at the same current density and capacity conditions with a voltage window of −0.5˜0.5 V. The Li-deposited CNT electrode was taken out of the Li|CNT cell, and rinsed in DOL to remove salts and then dried for further experiments.

### Cell Assembly and Testing Conditions

A carbonate-ester based electrolyte was prepared by dissolving 1.0 M lithium hexafluorophosphate (LiPF₆) (≥99.99%, Sigma Aldrich) and 0.05 M lithium difluoro (oxalate) borate (LiDFOB) (95.0%, AmBeed) in a solution of ethyl methyl carbonate (EMC, 99.9%, Sigma Aldrich) and 4-fluoro-1,3-dioxolan-2-one (fluoroethylene carbonate or FEC, >98.0%, TCI) with a volume ratio of 3:1. LiDFOB was used as an electrochemical reduction agent in the EMC/FEC electrolyte to have an inorganic Li—F and Li₂CO₃ rich SEI layer, which can induce uniform lithium growth and thereby suppress dendrite growth.

Li|SE|Li and Li|PP|Li symmetric cells for SEM and XPS characterization were assembled using 2032 coin cells with a Li metal foil (Rockwood, battery grade) whose thickness is 65 μm (total areal capacity ˜13.4 mAh cm⁻²) and diameter is 9.5 mm (⅜ inch). All the PP separators used in this study are Celgard 2500 whose thickness is ˜25 μm. The symmetric cells were tested using a Neware battery test instrument (BTS4000-5V10 mA) with a current density of 1.0 mA cm⁻² and a plating/stripping capacity of 2.0 mAh cm⁻². The amount of the carbonate-ester electrolyte used was 50 μL per cell. All the coin cell testing was carried out using electrodes whose diameters are 9.5 mm (⅜ inch) and separators whose diameters are 15.9 mm (⅝ inch).

The Li metal plating tests for Li|PP|CNT and Li|PP|Cu asymmetric cells were conducted using 2025 coin cells with the 200-μm thick lithium foil (total areal capacity ˜41.2 mAh cm⁻²) and the 3D CNT electrode without Li metal deposition or a Cu foil (9 μm in thickness) under a constant current (1.0 mA cm⁻²) discharge condition with a lower cut-off voltage of −0.5 V using an Arbin test instrument (LBT21084). The amount of the carbonate-ester electrolyte used was 50 μL per cell. The EIS measurement for both cells was conducted using a Gamry instrument (Interface 1010 E).

Li|SE|CNT asymmetric and Li|PP|Li symmetric cells employed the 65-μm thick Li foil as a cathode, the SE composite or PP membrane as a separator, and the 3D CNT or Cu foil with Li deposition of 6.0 mAh cm⁻² as an anode. The Neware battery test instrument was used to supply current densities of 0.5 mA cm⁻² or 1.0 mA cm⁻² and a capacity of 2.0 mAh cm⁻². The amount of the carbonate-ester electrolyte used was 50 μL per cell.

For the full cell tests, the NMC811 cathodes (areal capacityies of 2.0 mAh cm⁻² and 4.0 mAh cm⁻², respectively) and the LFP cathode (areal capacity of 1.25 mAh cm⁻²) were purchased from NEI Corporation. According to the specification sheet, the NMC811 cathode with an areal capacity of 2.0 mAh cm⁻² (NANOMYTE BE-56E, NEI Corp.) has a total loading of 10.64 mg cm⁻² and a total active material loading of 9.58 mg cm⁻² (±0.12 mg cm⁻²). The NMC811 cathode with an areal capacity of 4.0 mAh cm⁻² (Custom-made NANOMUTE BE-56E, NEI Corp.) has a total loading of 23.18 mg cm⁻² and the total active material loading of 20.86 mg cm⁻² (+0.2 mg cm⁻²). The LFP cathode (NANOMYTE BE-60E) has the total loading of 8.47 mg cm⁻² and the total active loading of 7.62 mg cm⁻² (±0.07 mg cm⁻²). All the full cells were assembled using 2025 coin cells. The NMC811 and LFP full cells were conducted with voltage windows of 2.8˜4.3 V and 2.5˜4.1 V (vs. Li/Li⁺), respectively, at room temperature. The values of 1 C rate for NMC811 and LFP were set as 200 and 170 mAh g⁻¹, respectively. The amount of the carbonate-ester electrolyte used for all the full cell tests was 40 μL per cell.

For the full cell test under the lean electrolyte condition, NMC811 cathodes with an areal capacity of 4.0 mAh cm⁻² were assembled using 2025 coin cells. The amount of the carbonate-ester electrolyte used for this test was 14 μL (4.3 g Ah-1) per cell. The voltage window range was 2.8-4.3 V and the value of 1 C rate was set as 200 mAh g⁻¹.

### In-Operando Cell Assembly

The in-operando cell was fabricated with a pouch cell and a cover glass (thickness No. 1) as a viewing window. The current collector was made by wrapping the Cu foil around microscope glass slides whose thickness is 1.0 mm. Li metal (99.9%, Alfa Aesar) was placed at one side of the Cu current collectors, and the separator was placed between the two electrodes. Then the two Cu/glass current collectors were pushed against each other. The pouch cell was filled with 500-μL electrolyte (1 M LiTFSI and 0.5 M LiNO₃ in a mixture of DOL and DME (1:1 by vol.)). All the lithium metal deposition processes were carried out at a current density of 4.0 mA cm⁻² and a capacity of 4.0 mAh cm⁻². The dark-field optical microscope (Olympus BX5) images were taken every 1 minute using Q capture Pro 6.0 software and the obtained images were integrated into video files by using the Windows Pictures application.

### Material Characterization

The X-ray diffraction (XRD) patterns were obtained by utilizing a BRUKER D8 equipment with a scan range (20) from 10° to 80° with a 0.05° sec-1 scanning speed at room temperature. The Fourier transform infrared (FTIR) spectroscopy analysis was performed using Thermo Nicolet 380 FTIR spectrometer between 4000 and 500 cm⁻¹ with a wavenumber resolution of 1 cm⁻¹ at room temperature. The dark-field optical microscope (Olympus BX5) images were taken using Q capture Pro 6.0 software. The SEM images were taken with a JEOL JSM-7500F filed-emission scanning electron microscope. The X-ray photoelectron spectroscopy (XPS) was carried out with an Omicron XPS system with DAR 400 dual Mg/Al X-ray source (<5×10⁻⁹ Torr condition).

### Electrochemical Measurements

The electrochemical oxidation stability of the separators was evaluated with a Li|separator|Li symmetric cell configuration by linear sweep voltammetry (LSV) at a scan rate of 5 mV s⁻¹ with a voltage window of 0˜8 V. The ionic conductivity (o) was obtained by Eq. 5 below:

$$σ = \frac{t}{{R}_{b} \times A} [ mS {cm}^{- 1} ] \qquad [ Eq . 5 ]$$

where R_{b} is a bulk impedance, t is the thickness of the separator, and A is a contact area between the separator and stainless steel (SS) current collector. The bulk impedance (R_{b}) was measured by electrochemical impedance spectroscopy (EIS) in a symmetric SS|separator|SS cell over a frequency range of 10⁵˜0.1 Hz.

The Li⁺ transference numbers (t_{Li+}) of the different separators were obtained from the chronoamperometry (CA) polarization and EIS before and after the polarization. EIS was recorded from 0.1 Hz to 100 kHz. CA was tested at a static potential (ΔV) of 10 mV for 5,000 sec. The galvanostatic polarization process was performed using the Arbin battery tester. Eq. 6 below was used to calculate t_{Li+}

$${t}_{{Li}^{+}} = \frac{{I}_{SS} ( ΔV - {I}_{0} {R}_{0} )}{{I}_{0} ( ΔV - {I}_{SS} {R}_{SS} )} \qquad [ Eq . 6 ]$$

where I₀ and I_{SS} are the initial and steady-state current, respectively. R₀ and R_{SS} are the electrolyte/electrode contact impedance measured before and after polarization, respectively, which were measured by EIS with an AC voltage of 5 mV after the five plating/stripping cycles at 1.0 mA cm⁻² and a 2.0 mAh cm⁻². The equivalent impedance circuit for the fitting is modeled with R_{bulk} in series with the parallel combination of R_{contact}/CPE, where R_{bulk} is the bulk impedance; R_{contact} is the electrolyte/electrode contact impedance; and CPE is a constant phase element. R₀ and R_{SS} were obtained from the x-intercepts of the fitted Nyquist plot.

### Finite Element Analysis Simulation Methods

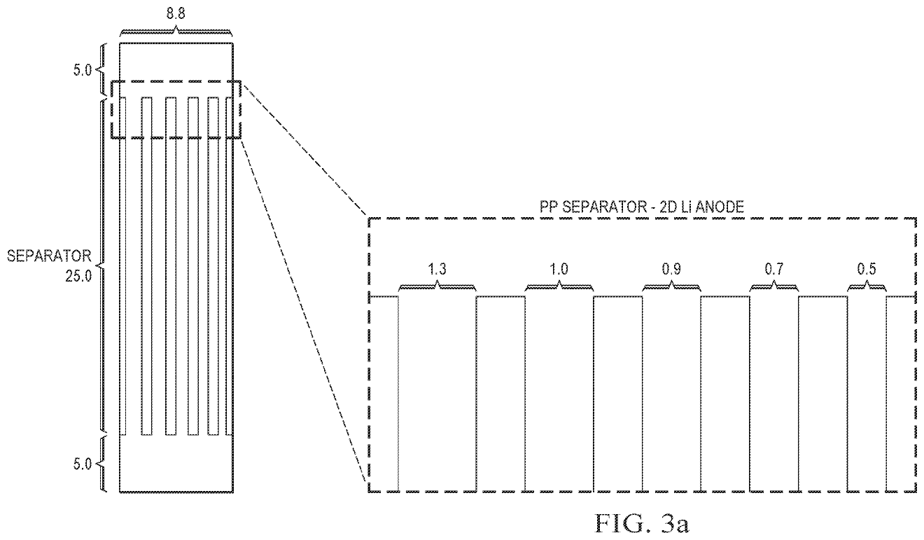

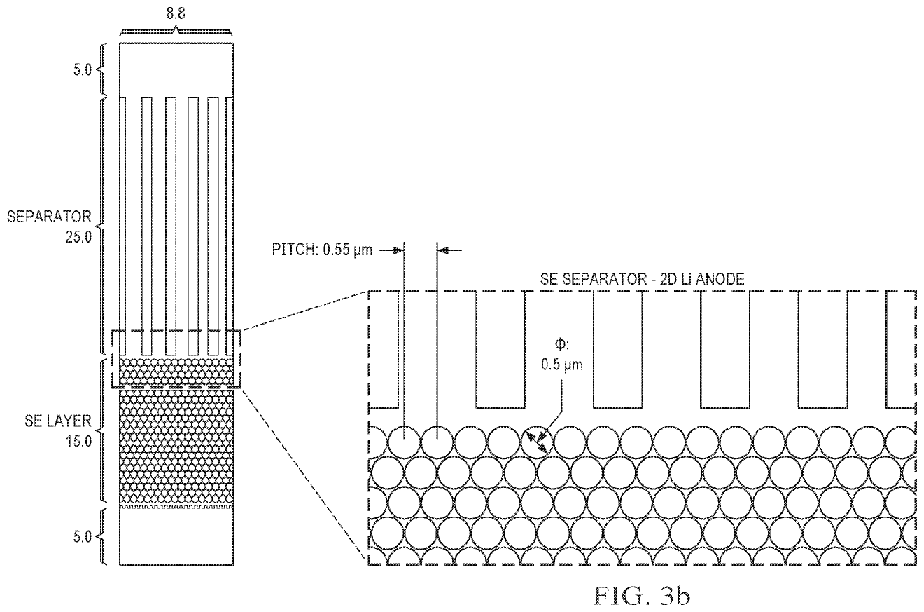

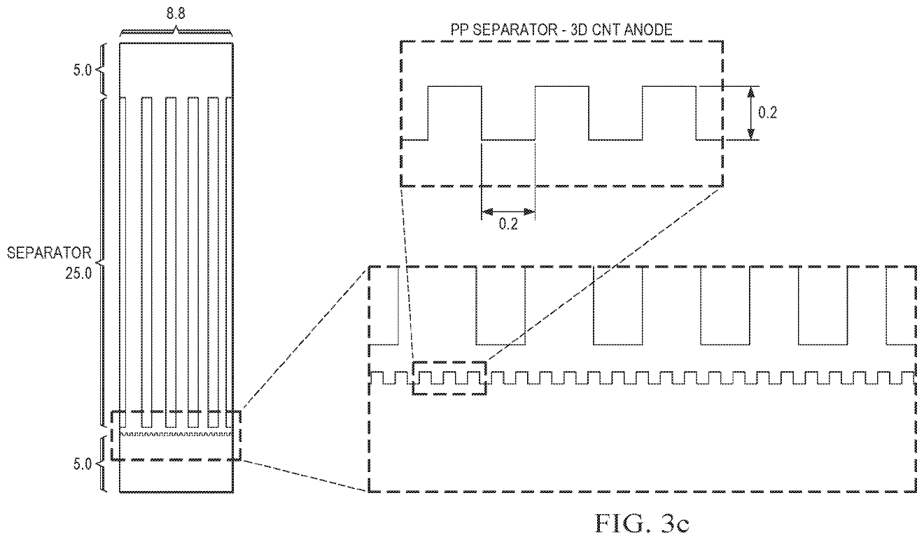

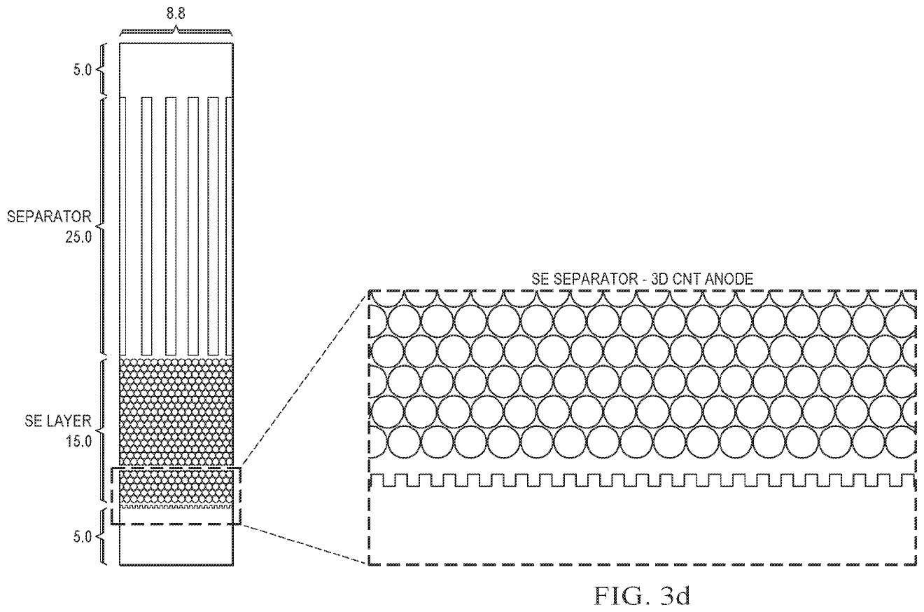

Finite Element Analysis (FEA) software (COMSOL Multiphysics 6.0) was used to analyze the migration and the concentration distribution of Li⁺ through different separator-anode pairs (PP|Li, SE|Li, PP|CNT, and SE|CNT). The geometrical domain structures of each case are represented in FIG. 3. Electrostatic and Transport of diluted species models were selected and coupled to simulate the simplified Li⁺ migration under an electrical potential gradient through PP and SE separators for both PP|Li and SE|Li pairs. Governing equations of the coupled physics are represented in Eqs. 7-9 below:

$$E = - ∇ V \qquad [ Eq . 7 ]$$

$$J = - D ∇ c + z μ FcE \qquad [ Eq . 8 ]$$

$$\frac{\partial c}{\partial t} = - ∇ J \qquad [ Eq . 9 ]$$

Where E is the electric field (V), V is the electric potential (V), J is the flux vector of Li⁺ (mol m⁻² s⁻²), D is the diffusion coefficient of Li⁺ (m² s⁻¹), c is Li⁺ concentration (mol m⁻³), z is the charge number of Li⁺, and F is a faraday constant.

For PP|CNT and SE|CNT pairs, Electrostatic model and Transport of diluted species in porous media model were coupled to simulate the Li⁺ migration. Equation S3 was used to define the electric potential through the system as same as in PP|Li and SE|Li case. To simulate the Li⁺ migration through the porous CNT domain, Eqs. 8 and 9 become Eqs. 10 and 11, respectively.

$$J = - {D}_{e} ∇ c + z μ FcE \qquad [ Eq . 10 ]$$

$$\frac{\partial {ε}_{{p}^{C}}}{\partial t} = - ∇ J \qquad [ Eq . 11 ]$$

$${D}_{e} = \frac{{ε}_{p}}{{τ}_{F}} {D}_{F} \qquad [ Eq . 12 ]$$

$${τ}_{F} = {ε}_{p}^{- 1 / 3} \qquad [ Eq . 13 ]$$

Where Dₑ in Eq. 12 is an effective diffusion coefficient (m² s⁻¹), εₚ in Eq. 13 is a porosity of the CNT, τ_{F} is Milington and Quirk model coefficient for calculating the effective diffusivity, and D_{F} is a diffusion coefficient of the CNT (m² s⁻¹). The geometrical domains to which the governing equations are applied were set as rectangular areas with a size of 8.8 μm by 35.0 μm (PP|Li, PP|CNT) and 8.8 μm by 50.0 μm (SE|Li, SE|CNT), respectively. PP separator was designed as a 25 μm thick rectangular geometry composed of five rectangular pores with different widths (1.32, 1.0, 0.88, 0.7, and 0.5 μm, respectively), which are completely filled with a liquid electrolyte, and uniform pore spacing (0.88 μm) to simulate the non-uniform pores on the surface. SE composite separator was designed by attaching a simplified PVDF-HFP/LLZTO composite layer below the PP separator by referring to the SEM image. CNT domain was designed as a corrugated feature with uniform 0.2 μm intervals between each space by referring to the SEM image of the slurry cast 3D CNT framework. The spacing between the top and bottom boundaries and the separator was set to 5.0 μm to investigate the concentration distribution in the vicinity of the bottom electrode surface. For the top surface boundary, the Dirichlet boundaries with V=20 mV and c=1.0 M were applied. For the bottom surface boundary, the Dirichlet boundaries with V=0 V and c=0 M were used to generate electrical potential difference and concentration gradient between two electrodes. The other boundaries were set as natural boundaries with zero flux conditions. The diffusion coefficients of liquid electrolyte, LLZTO particles, and CNT framework were selected as 3.0 E-10, 6.0 E-12, and 1.0 E-11, respectively according to the previously demonstrated reference results. The porosity (Ep) of the CNT structure was set as 0.3 by referring the theoretically calculated porosity of CNT anode with pre-deposited 10 mAh cm⁻² of Li metal. Li⁺ mobility (u) for liquid electrolyte and LLZTO particles were defined by the Nernst-Einsten equation. Li⁺ concentration gradients in the LLZTO particle domain are present with a diffusion coefficient of 6.0 E-12 m² s⁻¹ in the simulation. The concentration gradient ranged from is about 85000 to about 95000 mol m⁻⁴ within LLZTO domain. This internal Li⁺ concentration gradient may lead to additional Li⁺ migration through LLZTO. However, Li⁺ flux through LLZTO (on average 6.0E-7 mol m⁻²s⁻¹) is much smaller than that through the liquid electrolyte domain due to the low diffusivity of LLZTO compared to the liquid electrolyte. This implies that the major Li⁺ diffusion in the SE separator occurs through the pores inside the membrane which is filled with the electrolyte. The normalized Li⁺ concentration near the anode surface for each separator-anode pair were measured and calculated through the line which is placed under 100 nm from the bottom of the separator. Since the purpose of the simulation in this work focused on comparing Li⁺ migration propensity in the presence or absence of nanoporous structure of the SE separator and the normalized Li⁺ concentrations of each case were measured below the separator region (not at the surface with Dirichlet boundary condition), Faradaic reaction and Li plating behavior were not considered this work.

### Energy Density Calculation for the NMC811|SE|CNT Full Cell

To calculate the cell-level gravimetric energy density (E_{g}) of the NMC811|SE|CNT full cell, the following relations were used.

$${E}_{g} = \frac{{E}_{full cell}}{{m}_{electrode} + {m}_{sep .} + {m}_{Al . cc} + {m}_{Cu . cc} + {m}_{electrolyte}} = \frac{{V}_{avg} \cdot {m}_{AM} \cdot {C}_{s}}{{m}_{anode} + {m}_{cathode} + {m}_{sep .} + {m}_{Al . cc} + {m}_{Cu . cc} + {m}_{electrolyte}} \qquad [ Eq . 14 ]$$

E_{g}: Gravimetric energy density (Wh kg⁻¹)
E_{full cell}: Energy of the full cell (Wh)
V_{avg}: Theoretical discharge voltage (for the NMC811=3.85 VS11)
m_{AM}: Active material loading of the cathode (for the NMC811=20.86 mg cm⁻²)
Cₛ: Specific capacity of the full cell (mAh g⁻¹)
m_{electrode}: Areal mass of the cathode and anode (mg cm⁻²)
m_{sep.}: Areal mass of the separator (mg cm⁻²)
m_{Al.cc}: Areal mass of the aluminum current collector (mg cm⁻²)
m_{Cu.cc}: Areal mass of the copper current collector (mg cm⁻²)
m_{anode}: Areal mass of the anode (mg cm⁻²)
m_{cathode}: Areal mass of the cathode (mg cm⁻²)
m_{electrolyte}: Areal mass of the carbonate-ester electrolyte (mg cm⁻²)

To calculate the maximum gravimetric energy density of the NMC811|SE|CNT, V_{avg}=3.85 V, m_{AM}=20.86 mg cm⁻², the maximum Cₛ=201.2 mAh g⁻¹ at 34th cycle, m_{cathode} of the high loading NMC811 (4.0 mAh cm⁻²). The total mass (23.18 mg cm⁻²) of the cathode consists of 90% active material, 5% PVDF binder, and 5% Super P according to the manufacturer's specification.

The areal mass of the Li deposited CNT anode (m_{anode}) was obtained using the following relations.

$${m}_{anode} = {m}_{CNT} + {m}_{Li} = {m}_{CNT} + ( {C}_{Li} / {C}_{s Li theor .} ) \qquad [ Eq . 15 ]$$

m_{CNT}: Areal mass of the 3D CNT framework.
m_{Li}: Areal mass of the deposited lithium metal in the 3D CNT framework.
C_{Li depo.}: Areal capacity of the deposited Li (mAh cm⁻²).
C_{s Li theor.}: Specific theoretical capacity of Li metal (mAh g⁻¹).

For NMC811|SE|CNT full cell with the high loading NMC811 (4.0 mAh cm⁻²), 80-μm thick CNT framework was used, and the areal mass was 1.92 mg cm⁻². To have the N/P ratio of 2.5, Li metal with a capacity (C_{Li depo.}) of 10 mAh cm⁻² was deposited into the CNT framework. By dividing the theoretical capacity of Li metal (C_{s Li theor.}=3860 mAh g⁻¹), C_{Li depo.}/C_{s Li theor.}, the areal mass of the deposited lithium metal (m_{Li}) was obtained. Therefore, for the amount of 10 mAh cm⁻², m_{Li} was calculated to be 2.59 mg cm⁻². The total mass of the anode including the Li metal and CNT (m_{anode}) was ˜4.5 mg cm⁻².

The areal mass of the SE composite separator (total thickness of 40 microns) was calculated to be 2.07 mg cm⁻² based on the theoretical densities of solid-state electrolyte (SE), PVDF-HFP, and PP. Likewise, m_{Al.cc} and m_{Cu.cc} were calculated to be 2.03 mg cm⁻² and 4.03 mg cm⁻², respectively, where the effective thicknesses of Al and Cu are 7.5 μm and 4.5 μm, respectively.

The areal mass of the carbonate-ester electrolyte was calculated by applying the calculated theoretical density of the 1M LIPF₆ and 0.05M LIDFOB in the EMC and FEC with a volume ratio of 3:1 electrolyte (1.29 g cm-3). To calculate the gravimetric cell-level energy density, the following two assumptions were considered. First, the entire pore volume of the cathode, anode, and separator are filled with electrolyte. According to the porosity, area, and thickness of the electrodes and separator, the total areal volume of the electrolyte to fill the pore was calculated as 0.00698 cc cm⁻² (0.00218554 cc cm⁻² for the cathode, 0.002219 cc cm⁻² for the anode, and 0.002575 cc cm⁻² for the separator). Therefore, the areal mass of the electrolyte (9 mg cm⁻²) to fill the pore was achieved by multiplying the density and the areal volume. By considering the area of each component (1.2667 cm² for the cathode and the anode, and 1.979 cm² for the separator), the total volume of the electrolyte to fill the pore was calculated to be 10.67 μL. The 3.33 μL of the excess electrolyte was added to the system since we used 14 μL in the full cell. Note that we did not have the formation process (which is typical in fabricating commercial cells). Therefore, some of the electrolyte should have been used to form the SEI layer. The areal mass of the extra amount of the electrolyte (3.33 μL) was calculated as 3.39 mg cm⁻² by considering the density of the electrolyte (1.29 g cm⁻³) and the area of the electrode (1.2667 cm⁻²). Therefore, the total areal mass of the carbonate-ester electrolyte (m_{electrolyte}) was calculated to be 12.39 mg cm⁻².

According to the aforementioned procedure, the maximum gravimetric energy density (Wh kg⁻¹) of the NMC811|SE|CNT full cell was obtained as follows.

$${E}_{g} = \frac{{V}_{avg} \cdot {m}_{AM} \cdot {C}_{s}}{{m}_{anode} + {m}_{cathode} + {m}_{sep .} + {m}_{Al . cc} + {m}_{Cu . cc} + {m}_{electrolyte}} = \frac{3.85 [ V ] \cdot 20.86 [ mg / {cm}^{- 2} ] \cdot 20.12 [ mAh / g ]}{4.5 [ mg / {cm}^{- z} ] + 23.33 [ mg / {cm}^{- 2} ] + 2.07 [ mg / {cm}^{- 2} ] + 2.03 [ mg / {cm}^{- 2} ] + 4.03 [ mg / {cm}^{- 2} ] + 12.39 [ mg / {cm}^{- 2} ]} = \sim 334 [ Wh / kg ] \qquad [ Eq . 16 ]$$

To calculate the maximum volumetric energy density (Eᵥ) of the NMC811|SE|CNT full cell, the following relations were used.

$${E}_{v} = \frac{{E}_{full cell}}{{∀}_{total}} = \frac{{V}_{d} \cdot {m}_{AM} \cdot {C}_{s}}{{t}_{anode} + {t}_{cathode} + {t}_{Al , Cu , Separator}} \qquad [ Eq . 17 ]$$

Eᵥ: Gravimetric energy density (Wh kg⁻¹)
E_{full cell}: Energy of the full cell (Wh)
V_{d}: Nominal discharge voltage (for the NMC811=3.85 V)
m_{AM}: Active material loading of the cathode (for the NMC811=20.86 mg cm⁻²)
Cₛ: Specific capacity of the full cell (mAh g⁻¹)
∀ₜₒₜₐₗ: Total volume of the full cell including anode, cathode, current collectors, and separator (L)
t_{anode}: Thickness of the anode (For the NMC811|SE|CNT, total thickness of the CNT anode, μm)
t_{cathode}: Thickness of the cathode (NMC811 layer with a 4.0 mAh cm⁻² areal capacity, μm)
t_{Al,Cu,Separator}: Summation of the thickness of the separator (SE composite separator, 40 μm), the effective thickness of the Al current collector at the cathode side (7.5 μm), and the effective thickness of the Cu current collector at the anode side (4.5 μm).

To calculate the maximum volumetric energy density of the NMC811|SE|CNT, V_{avg}=3.85 V, m_{AM}=20.86 mg cm⁻², the maximum Cₛ=201.2 mAh g⁻¹ at 40th cycle, t_{anode} of the CNT anode with the 10 mAh cm⁻² amount of the lithium metal deposited was measured to be 80 μm. t_{anode} was measured immediately after completing the lithium metal deposition process in the Ar-filled glove box using a micrometer. t_{cathode} was measured to be 74.46 μm, and t_{Al,Cu,Separator} was 52.0 μm. Then, the maximum volumetric energy density (Wh L⁻¹) of the NMC811|SE|CNT full cell was obtained as follows.

$${E}_{v} = \frac{{V}_{d} \cdot {m}_{AM} \cdot {C}_{s}}{{t}_{anode} + {t}_{cathode} + {t}_{Al , Cu , Separator}} = \frac{3.85 [ V ] \cdot 20.86 [ mg / {cm}^{- z} ] \cdot 201.2 [ mAh / g ]}{80 [ μm ] + 74.46 [ μm ] + 52 [ μm ]} = ∼ 783 [ Wh {L}^{- 1} ] \qquad [ Eq . 18 ]$$

### Cell-Level Energy Density Calculations for the Commercial Li-Ion Batteries

The cell-level gravimetric energy density values (including cathode, anode, separator, electrolyte, and current collectors) of the commercial Li-ion batteries consisting of graphite anodes paired with LiNi_{1-x-y}CoₓMn_{y}O₂ (NMC) or LiMn₂O₄—LiNi_{1-x-y}CoₓMn_{y}O₂ (LMO-NMC) cathode are shown in Table 6. Their specific energy (Wh kg⁻¹), capacity (Ah), and discharge voltage (V) data are available in the literature. The weight fractions occupied by each component are 41% for the cathode, 18% for the anode, 4% for the aluminum current collector, 7% for the copper current collector, 17% for the housing, 3% for the separator, and 10% for the electrolyte). As for the cell-level gravimetric energy density of the commercial cells were calculated by dividing the specific energy density with 0.83 (83%) considering all of the components except the housing. For the volumetric energy density of the commercial cells, we assumed that the external housing is thin enough to neglect the volume of the casing, and the volumetric energy density results from the literature were cited without modification.

### Preparation of a CNT Interlayer

A three-dimensional connected carbon nanotube was grown by a chemical vapor deposition. As-grown 3D CNT structure was sliced and acidic treated to un-zip by mechanochemical treatment. After mechanochemical treatment, the 3D CNT sponge was smashed by the mechanical milling process and the sphere shape of 3D CNT chunks with 45 to 100 μm diameter. 0.75 g of poly (vinylidene fluoride-co-hexafluoropropylene) (PVDF-hfp, MW ˜400,000, Sigma Aldrich) was dissolved in 5 mL of acetone (Maron fine chemicals, USA). The microsphere CNTs chunks were mixed with 0.1 mL PVDF-hfp acetone solution (CNT:PVDF-hfp mass ratio=100:30) in 2 mL of acetone for preparation of the CNT layer.

For the comparison study, the amount of CNT, PVDF-hfp mass and the additional volume of acetone is shown in Table 9.

TABLE 9
CNT and PVDF-hfp, Acetone composition.

| CNT:PVDF- hfp ratio | | CNT (mg) | PVDF-hfp (mg) | Acetone (mL) |
|---|---|---|---|---|
| 1: | 1 | 25 | 25 | 1.54 |
| | 0.5 | 40 | 20 | 1.85 |
| | 0.3 | 50 | 15 | 2 |
| | 0.1 | 50 | 5 | 1.69 |

1 mL of CNT-PVDF-hfp acetone solution was dropped on the glass substrate and blade with 200 μm of gap for under CNT layer. After fully solvent was fully dried, the bare PVDF-hfp layer was casted on the CNT layer with the same tape-casting method with 400 μm of gap. The CNT-PVDF-hfp protective films were peeled from the substrate and kept in the air for further experiments. For casting on the polypropylene Celgard separator, the CNT-PVDF-hfp solution dropped on the PP separator (Celgard 2400, Celgard) tightly attached on a glass plate and peeled off with PP-CNT-PVDF-hfp layer together after fully drying process.

### Electrochemical Characterization

Li|Li symmetry cells (using CR 2025-coin cells) were assembled with one pair of lithium metal (Alfa Aesar, 99.9%) anode (½ inch in diameter) along with the CNT protective layer (⅝ inch in diameter) with 30 μL electrolyte. The electrolyte was prepared with dissolving 1 M LiTFSI (Sigma-Aldrich, 99%) and 0.5 M LiNO₃ (Alfa Aesar, 99%) in a mixture of 1,3-dioxolane (Alfa Assar, 99.5%) and 1,2-dimethoxyethane (Alfa Aesar, 99+%) (1:1 by vol.) before cell assembly. Electrochemical analysis was conducted using an electrochemical workstation (CHI604D) over a frequency range from 100 kHz to 0.01 Hz with an AC amplitude of 5 mV. All experiments were conducted at room temperature. From the Nyquist plot obtained from EIS, the ionic conductivities were obtained by following equation.

$$δ = \frac{ι}{{R}_{b} \times A} \qquad [ Eq . 19 ]$$

Where, δ is ionic conductivity (S cm⁻¹), l is layer thickness (cm), R_{b} is the bulk resistance (Ω) and A is the area of layer (cm²).

Lithium-ion transfer number (t_{Li}_{⁺}) was obtained by an AC-DC combined technique. The original resistance (R₀) was measured by AC impedance as above description and the steady-state polarization plot was recorded by applying a DC voltage of 10 mV for 6000 seconds, and the initial current (I₀), the steady-state current (Iₛ) and the polarization voltage (ΔV=0.01V) were collected. After the DC polarization, the steady state resistance (Rₛ) was measured again by AC impedance. The t_{Li}_{⁺} is calculated by following equation.

$${t}_{{Li}^{+}} = \frac{{I}_{S} ( ΔV - {I}_{0} {R}_{0} )}{{I}_{0} ( ΔV - {I}_{S} {R}_{S} )} \qquad [ Eq . 20 ]$$

Using the symmetry cell, critical current density also was obtained by a galvanostat (LandT CT2001). The current density began at 0.05 mA cm⁻² and increased from 0.1 mA cm⁻² to 2.5 mA cm⁻² in every 0.1 mA cm⁻² and all the charge/discharge steps last for 0.5 hour.

### Result and Discussion

CNT coated PVDF-hfp separators were fabricated by a double-layer-tape casting method and characterized with FE-SEM (JEOL JSM-7500F). The three-dimensional connected CNT sponge was smashed by ball-milling process and selected between 45˜100 μm of size through the sieve. The sized CNTs chunks still had mechanochemically treated trenches (unzipped) on the CNTs. The CNTs chunks were dispersed in acetone with fully dissolved PVDF-hfp and casted on the glass substrate. While drying the CNT-PVDF-hfp acetone solution, the CNT was laid on the substrates, aligned in planar direction. The CNT film has a 2˜3 μm of thickness thinner than CNT chunks diameter (estimated about 25 μm), indicating the CNTs chunks got stacked during the drying process. About 15˜17 μm thickness of insulating layer was casted with pure PVDF-hfp solution on the CNTs layer. During the tape-casting, PVDF-hfp tends to submerge to the bottom side, which forms a thin layer covered CNTs. As the ratio of PVDF-hfp composition increased 0.1, 0.3, 0.5, and 1, the PVDF-hfp were well distributed along with the CNT layers and formed a continuous layer with the upper layer.

Although various embodiments of the present disclosure have been illustrated in the accompanying Drawings and described in the foregoing Detailed Description, it will be understood that the present disclosure is not limited to the embodiments disclosed herein, but is capable of numerous rearrangements, modifications, and substitutions without departing from the spirit of the disclosure as set forth herein.

The term “substantially” is defined as largely but not necessarily wholly what is specified, as understood by a person of ordinary skill in the art. In any disclosed embodiment, the terms “substantially”, “approximately”, “generally”, and “about” may be substituted with “within [a percentage] of” what is specified, where the percentage includes 0.1, 1, 5, and 10 percent.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure, and that they may make various changes, substitutions, and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a”, “an”, and other singular terms are intended to include the plural forms thereof unless specifically excluded.

Conditional language used herein, such as, among others, “can”, “might”, “may”, “e.g.”, and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

Although various embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

1. An electrode comprising:
a porous carbon nanotube (CNT) electrode;
a solid-state electrolyte (SE) composite layer disposed on the porous CNT electrode; and
a polypropylene (PP) separator layer disposed on the SE composite layer.

2. The electrode of claim 1, wherein the SE composite layer comprises Li_{6.4}La₃Zr_{1.4} Ta_{0.6}O₁₂ (LLZTO) and poly(vinylidene fluoride-co-hexafluoropropylene (PVDF-HFP).

3. The electrode of claim 2, wherein the LLZTO comprises about 40-99 wt. % of the SE composite layer.

4. The electrode of claim 1, wherein the SE composite layer comprises one or more of LLZTO, Li_{1.5}Al_{0.5}Ti_{1.5}(PO₄)₃ (LATP), Li₆PS₅Cl (Argyrodite), or Li₁₀GeP₂S₁₂ (LGPS).

5. The electrode of claim 4, wherein the SE composite layer further comprises one or more of poly(ethylene oxide) (PEO), polyimide (PI), polyacrylonitrile (PAN), or poly(vinylidene fluoride-co-hexafluoropropylene (PVDF-HFP).

6. The electrode of claim 1, wherein the porous CNT electrode comprises carboxyl functional groups.

7. The electrode of claim 1, wherein the porous CNT electrode comprises polyvinylidene fluoride.

8. A solid-state anode-free Li metal battery comprising:
a separator composite layer; and
an elastic porous layer configured to change volume when the battery undergoes a charge or discharge process.

9. The battery of claim 8, wherein the separator composite layer comprises SE.

10. The battery of claim 9, wherein the SE comprises one or more of LLZTO, LATP, Argyrodite, or LGPS

11. The battery of claim 10, wherein the SE further comprises one or more of PEO, PI, PAN, or PVDF-HFP.

12. The battery of claim 8, wherein the elastic porous layer comprises a CNT sponge.

13. The battery of claim 12, wherein the elastic porous layer further comprise an artificial solid electrolyte interphase (SEI) layer.

14. The battery of claim 13, wherein the SEI layer comprises one or more of Li₁₃In₃, LiZn, Li₃Bi, or Li₃As.

15. A method of making an anode, the method comprising:
applying an SE composite layer to a porous CNT electrode while the SE composite is in an uncured state; and
applying a PP separator on top of the SE composite.

16. The method of claim 15, wherein the SE composite layer comprises LLZTO and PVDF-HFP.

17. The method of claim 16, wherein the LZTO comprises about 40-60 wt. % of the SE composite layer.

18. The method of claim 15, wherein the porous CNT electrode comprises polyvinylidene fluoride.

19. The method of claim 15, wherein the SE composite layer further comprises one or more of poly(ethylene oxide) (PEO), polyimide (PI), polyacrylonitrile (PAN), or poly(vinylidene fluoride-co-hexafluoropropylene (PVDF-HFP).

20. The method of claim 15, further comprising incorporating the anode into a battery.
